(19) United States
(12) Patent Application Publication
(10) Pub. No.: US 2026/0085000 A1
(43) Pub. Date: Mar. 26, 2026

(54) GLASS SUBSTRATE

(71) Applicant: NIPPON ELECTRIC GLASS CO., LTD., Otsu-shi, Shiga (JP)

(72) Inventor: Masaki MAKITA, Otsu-shi Shiga (JP)

(73) Assignee: NIPPON ELECTRIC GLASS CO., LTD., Otsu-shi, Shiga (JP)

(21) Appl. No.: 19/127,448

(22) PCT Filed: Dec. 6, 2023
(86) PCT No.: PCT/JP2023/043610

§ 371 Date: May 6, 2025

(30) Foreign Application Priority Data
Dec. 26, 2022 (JP) 2022-208657

(51) Int. Cl. C03C 3/118; C03C 3/112

(52) U.S. Cl. CPC C03C 3/118; C03C 3/112

(57) ABSTRACT

A glass substrate according to the present invention contains, as a glass composition, in mol %, from 65% to 80% of SiO₂, from 5.2% to 25% of Al₂O₃, from 0% to 15% of B₂O₃, from 0.001% to less than 0.1% of Li₂O+Na₂O+K₂O, from 0% to 15% of MgO, from 0% to 15% of CaO, from 0% to 15% of SrO, from 0% to 2.9% of BaO, from 1% to 20% of MgO+CaO+SrO+BaO, and from 0% to 1% of SnO₂.

### TECHNICAL FIELD

The present invention relates to a glass substrate, and more particularly to a glass substrate suitable for processing to form a through hole by chemical etching.

### BACKGROUND ART

In a micro LED (light emitting diode) display, particularly a tiling type micro LED display in which a plurality of display panels using micro LEDs are arranged, it is necessary to make boundaries between the display panels (tiles) difficult to be visually recognized. Therefore, a glass substrate used for the above application preferably has a through hole prepared in a thickness direction of the glass substrate to ensure electrical continuity between front and back surfaces of the glass substrate. With such a configuration, a light emitting element can be driven from the back surface of the glass substrate (see Patent Literature 1).

As a method of preparing the through hole in the thickness direction of the glass substrate, there is known a method of forming a through hole by, for example, preparing a modified portion inside a glass substrate by irradiation with laser light and then removing the modified portion by chemical etching (see Patent Literature 2).

### CITATION LIST

### Patent Literature

Patent Literature 1: JP2018-205525A
Patent Literature 2: JP6333282B

### SUMMARY OF INVENTION

### Technical Problem

In recent years, in order to achieve a higher definition in the micro LED display, it is required to prepare through holes at a higher density in a main surface of a glass substrate. According to such a configuration, it is possible to increase a wiring density of the display, that is, a pixel density.

In order to prepare a plurality of through holes at a high density in the main surface of the glass substrate, it is preferable to reduce an opening diameter of the through hole.

Specifically, in the case of preparing a through hole by using the method in the above Patent Literature 2, since the chemical etching gradually progresses from the main surface toward the inside of the glass substrate, there is a tendency that a tapered shape having a portion narrowed in a vertical direction from each of the two main surfaces of the glass substrate is formed. In the case where a taper angle is large, it is necessary to increase the opening diameter (Φ1 and Φ2 in FIG. 2 to be described later) in order to ensure the inner diameter dimension of the through hole. Therefore, in order to ensure a necessary inner diameter dimension and reduce the opening diameter, it is important to control the shape so as to reduce the taper angle (Φ1 and Φ2 in FIG. 2) of the through hole, that is, close to a straight through hole having a constant inner diameter.

The taper angle of the through hole is thought to be determined by a ratio of an expansion speed of the hole in the thickness direction to an expanding speed of the opening diameter during the etching (that is, an etching rate of the glass substrate before modification). When the expanding speed of the opening diameter is reduced, the taper angle can be reduced. Therefore, it is important to decrease the etching rate in order to prepare a through hole having a small taper angle.

One method of reducing the etching rate of the glass substrate is to increase a content of SiO₂ in a glass composition. However, when the content of SiO₂ in the glass substrate is increased, there is a problem that the meltability decreases and a melting cost is likely to increase. On the other hand, when the glass component other than SiO₂ is adjusted to enhance the meltability of the glass substrate, there is a problem that the glass is likely to undergo phase separation and the glass is cloudy and is likely to have a small transmittance.

An object of the present invention is to provide a glass substrate that has high meltability, is less likely to undergo phase separation, and has a low etching rate in chemical etching.

### Solution to Problem

As a result of repeating various experiments, the inventor of the present invention has found that the above technical problem can be solved by strictly regulating a glass composition of a glass substrate, and proposes the finding as the present invention. That is, a glass substrate according to the present invention contains, as a glass composition, in mol %, from 65% to 80% of SiO₂, from 5.2% to 25% of Al₂O₃, from 0% to 15% of B₂O₃, from 0.001% to less than 0.1% of Li₂O+Na₂O+K₂O, from 0% to 15% of MgO, from 0% to 15% of CaO, from 0% to 15% of SrO, from 0% to 2.9% of BaO, from 1% to 20% of MgO+CaO+SrO+BaO, and from 0% to 1% of SnO₂. Note that, “Li₂O+Na₂O+K₂O” refers to the total amount of Li₂O, Na₂O, and K₂O. In addition, “MgO+CaO+SrO+BaO” refers to the total amount of MgO, CaO, SrO, and BaO.

In addition, the glass substrate according to the present invention preferably contains, as a glass composition, in mol %, from 68.9% to 80% of SiO₂, from 5.2% to 25% of Al₂O₃, from 0% to 10% of B₂O₃, from 0.001% to less than 0.1% of Li₂O+Na₂O+K₂O, from 0% to 15% of MgO, from 0% to 7.1% of CaO, from 0% to 15% of SrO, from 0% to 1% of BaO, from 1% to 20% of MgO+CaO+SrO+BaO, from 0% to 1% of SnO₂, from 0.0005% to 0.1% of TiO₂, from 0% to less than 0.05% of As₂O₃, and from 0% to less than 0.05% of Sb₂O₃, in which a molar ratio CaO/(MgO+CaO+SrO+BaO) is from 0 to 0.67, and a molar ratio SrO/(MgO+CaO+SrO+BaO) is from 0.14 to 1. Note that, “CaO/(MgO+CaO+SrO+BaO)” is a value obtained by dividing the content of CaO by the total amount of MgO, CaO, SrO, and BaO. In addition, “SrO/(MgO+CaO+SrO+BaO)” is a value obtained by dividing the content of SrO by the total amount of MgO, CaO, SrO, and BaO.

It is preferable that, the glass substrate according to the present invention contains, as a glass composition, in mol %, from 0% to 0.85% of BaO.

According to such a configuration, a through hole or a non-through hole having a small taper angle can be easily prepared, and a glass substrate having good meltability can be easily obtained.

In addition, the glass substrate according to the present invention preferably contains, as a glass composition, in mol %, from 69.1% to 80% of SiO₂, from 5.2% to 25% of Al₂O₃, from 1.1% to 8.5% of B₂O₃, from 0.001% to less than 0.1% of Li₂O+Na₂O+K₂O, from 0.1% to 15% of MgO, from 0% to 7.1% of CaO, from 0.6% to 15% of SrO, from 0% to 1% of BaO, from 1% to 20% of MgO+CaO+SrO+BaO, from 0% to 4% of ZnO, from 0.01% to 1% of SnO₂, from 0% to 0.4% of MoO₃, from 0% to less than 0.05% of As₂O₃, and from 0% to less than 0.05% of Sb₂O₃, in which a molar ratio MgO/(MgO+CaO+SrO+BaO) is from 0.1 to 0.86, a molar ratio CaO/(MgO+CaO+SrO+BaO) is from 0 to 0.51, a molar ratio SrO/(MgO+CaO+SrO+BaO) is from 0.14 to 0.99, and a molar ratio BaO/(MgO+CaO+SrO+BaO) is from 0 to 0.06. Note that, “MgO/(MgO+CaO+SrO+BaO)” is a value obtained by dividing the content of MgO by the total amount of MgO, CaO, SrO, and BaO. In addition, “BaO/(MgO+CaO+SrO+BaO)” is a value obtained by dividing the content of BaO by the total amount of MgO, CaO, SrO, and BaO.

It is preferable that, the glass substrate according to the present invention contains, as a glass composition, in mol %, from 0% to 4.9% of CaO.

According to such a configuration, a through hole or a non-through hole having a small taper angle can be easily prepared, and a glass substrate having good devitrification resistance can be easily obtained.

It is preferable that, in the glass substrate according to the present invention, a HF etching rate is 2.00 μm/min or less. Here, the “HF etching rate” refers to a value measured by using the following method. First, both front and back main surfaces of a glass substrate sample are optically polished and then annealed, and a part of the main surface is covered with a mask and masked. 300 mL of a HF solution having a concentration of 2.5 mol/L is set to a solution temperature of 30° C. using a water bath stirrer and stirred at about 600 rpm. The glass substrate sample is immersed in the HF solution for 20 minutes. Thereafter, the mask is removed, the glass substrate sample is washed, and a step between a masked non-etched portion and a portion eroded by etching is measured using a Surfcorder (ET4000A, manufactured by Kosaka Laboratory Ltd.). The etching rate is calculated by dividing the value by an immersion time.

According to such a configuration, it is possible to further reduce the taper angle in preparing the hole.

It is preferable that, in the glass substrate according to the present invention, the glass substrate having a thickness of 1 mm has a linear transmittance of 89.5% or more at a wavelength of 450 nm.

According to such a configuration, light in a blue wavelength band can be satisfactorily transmitted, and a glass substrate suitable as a member constituting a blue LED can be obtained.

It is preferable that the glass substrate according to the present invention has a temperature of 1750° C. or lower at a viscosity in high temperature of 10^{2.5} dPa·s. Note that, the “temperature at a viscosity in high temperature of 10^{2.5} dPa·s” can be measured by, for example, using a platinum sphere pull up method.

According to such a configuration, the molten glass is easily formed into a sheet shape.

It is preferable that the glass substrate according to the present invention has a through hole or a non-through hole.

According to such a configuration, for example, a glass substrate suitable for applications such as an electronic device such as a micro LED display and a glass interposer can be obtained.

It is preferable that, in the glass substrate according to the present invention, the through hole or the non-through hole includes a tapered portion, and the tapered portion has an average taper angle of from 0° to 13.0°.

According to such a configuration, an opening diameter of the through hole or the non-through hole in a main surface of the glass substrate can be reduced, and a plurality of holes can be easily formed at a high density. 5

It is preferable that, in the glass substrate according to the present invention, the through hole or the non-through hole has an opening diameter of from 1 μm to 200 μm.

According to such a configuration, a plurality of holes can be easily formed at a high density in the main surface of the glass substrate, and a pixel density of a display using the glass substrate according to the present invention can be increased.

It is preferable that, in the glass substrate according to the present invention, the glass substrate has the through hole, the through hole has a narrowed portion therein, and the narrowed portion has an inner diameter of from 1 μm to 200 μm.

According to such a configuration, a plurality of through holes can be easily formed at a high density in the main surface of the glass substrate, and the pixel density of the display using the glass substrate according to the present invention can be increased.

It is preferable that, in the glass substrate according to the present invention, the glass substrate has an etched surface, and the etched surface has a surface roughness Sa of from 0.05 nm to 4 nm. Note that, in the present invention, the “etched surface” refers to a front surface of the glass after being etched by chemical etching.

According to such a configuration, when a TFT (thin film transistor) is prepared on a glass substrate as a display application, the reliability is enhanced, and when a plating film is prepared on the surface of the glass substrate, the adhesion of the plating film to the glass substrate due to an anchor effect can be enhanced.

### Advantageous Effects of Invention

According to the present invention, it is possible to provide a glass substrate that can be formed with through holes in high linearity due to a low etching rate, and that is less likely to undergo phase separation, has excellent meltability, and has excellent productivity.

### BRIEF DESCRIPTION OF DRAWINGS

FIG. 1 is a schematic plane diagram of a glass substrate having through holes according to an embodiment of the present invention.

FIG. 2 is a schematic cross-sectional view of the glass substrate having through holes according to the embodiment of the present invention.

FIG. 3 is a schematic cross-sectional view of a glass substrate having non-through holes according to another embodiment of the present invention.

FIG. 4 is a schematic cross-sectional view of a glass substrate according to another embodiment of the present invention, which is provided with through holes having no narrowed portion inside a glass.

### DESCRIPTION OF EMBODIMENTS

A glass substrate according to the present invention contains, as a glass composition, in mol %, from 65% to 80% of SiO₂, from 5.2% to 25% of Al₂O₃, from 0% to 15% of B₂O₃, from 0.001% to less than 0.1% of Li₂O+Na₂O+K₂O, from 0% to 15% of MgO, from 0% to 15% of CaO, from 0% to 15% of SrO, from 0% to 2.9% of BaO, from 1% to 20% of MgO+CaO+SrO+BaO, and from 0% to 1% of SnO₂. The reason for limiting the content of each component as described above is as follows. Note that, in the description of the content of each component, % represents mol % unless otherwise indicated. Unless otherwise stated, in the present description, a numerical range indicated using “to” means a range that includes the numerical values listed before and after “to” as the minimum value and the maximum value, respectively.

SiO₂ is a component that forms a glass network. When the content of SiO₂ is too small, the chemical resistance decreases. In particular, since a HF etching rate increases, an expanding speed of an opening diameter increases in forming a through hole, and a taper angle of the through hole or a non-through hole is increased. Therefore, a suitable lower limit range for SiO₂ is 65% or more, 68% or more, 68.2% or more, 68.4% or more, 68.6% or more, 68.8% or more, 68.9% or more, 69% or more, 69.1% or more, 69.2% or more, 69.4% or more, 69.6% or more, 69.7% or more, 69.8% or more, and particularly 69.9% or more. In addition, SiO₂ is a component that dissolves in a HF solution when etching a glass substrate with the solution, and does not leave a residue. Therefore, when a large amount of SiO₂ is contained in the glass, the amount of residues generated during the etching is reduced and residue clogging is less likely to occur in an etching device. Therefore, a load in treating the residues is reduced, and a cost required for treating the residues is likely to reduce. In particular, in the case where the content of SiO₂ is 68.9% or more, the amount of residues is remarkably reduced and the HF etching rate is also reduced, so that the taper angle of the through hole or the non-through hole can be further reduced. On the other hand, when the content of SiO₂ is too large, there is a concern that a viscosity in high temperature is increased or an undissolved residue of a raw material for introducing SiO₂ is generated, and the glass is difficult to melt. Therefore, a suitable upper limit range for SiO₂ is 80% or less, 78% or less, 76% or less, 75.8% or less, 75.5% or less, 75.3% or less, 75.1% or less, and particularly 75% or less.

Al₂O₃ is a component that forms the glass network and is a component that enhances the chemical resistance. When the content of Al₂O₃ is too small, the chemical resistance decreases, and in particular, the HF etching rate is likely to increase. In addition, the glass is likely to undergo phase separation, and the glass substrate is cloudy and is likely to have a small transmittance. In addition, a surface roughness of a main surface of the glass substrate after HF etching is likely to increase. Therefore, a suitable lower limit range for Al₂O₃ is 5.2% or more, 5.5% or more, 6% or more, 7% or more, 7.1% or more, 7.3% or more, 7.5% or more, 7.7% or more, 8% or more, 8.6% or more, 8.7% or more, 8.8% or more, 8.9% or more, 9% or more, and particularly 9.1% or more. On the other hand, when the content of Al₂O₃ is too large, devitrified crystals such as mullite are likely to precipitate, and a liquidus viscosity is likely to decrease. In addition, since the residues generated during HF etching are salts composed of alkaline earth elements, Al, and F, when the content of Al₂O₃ is too large, the amount of residues generated by HF etching increases, and residue clogging is likely to occur in the etching device. Therefore, an upper limit range for Al₂O₃ is 25% or less, 21% or less, 18% or less, 17.6% or less, 17.5% or less, 17% or less, 16% or less, 15.5% or less, 15% or less, 14% or less, 13% or less, 12.8% or less, 12.5% or less, 12.3% or less, and particularly 12% or less.

B₂O₃ is a component that enhances the meltability and the devitrification resistance. When the content of B₂O₃ is too small, the meltability and the devitrification resistance is likely to decrease. Therefore, a suitable lower limit range for B₂O₃ is 0% or more, 0.1% or more, 0.5% or more, 0.6% or more, 1% or more, 1.1% or more, 1.5% or more, 2% or more, 2.1% or more, 2.3% or more, 2.4% or more, 2.5% or more, 2.6% or more, 2.7% or more, 2.8% or more, 3.1% or more, 3.4% or more, 3.5% or more, and particularly preferably 4% or more. In addition, B₂O₃ is a component that dissolves in the HF solution when etching the glass substrate with the solution, and does not leave a residue. Therefore, when a large amount of B₂O₃ is contained in the glass, the amount of residues generated during the etching is reduced and residue clogging is less likely to occur in the etching device. Therefore, the load in treating the residues is reduced, and the cost required for treating the residues is likely to reduce. In particular, when the content of B₂O₃ is 2.0% or more, the above effects are likely to be obtained. On the other hand, when the content of B₂O₃ is too large, the chemical resistance decreases, and in particular, the HF etching rate is likely to increase. In addition, the glass is likely to undergo phase separation, and in addition, the surface roughness of the front surface of the glass after HF etching is likely to increase. Therefore, an upper limit amount for B₂O₃ is 15% or less, 12.5% or less, 10% or less, 9.5% or less, 9.4% or less, 9% or less, 8.6% or less, 8.5% or less, 8.4% or less, 8.3% or less, 8% or less, 7.7% or less, 7.6% or less, 7.5% or less, 7.4% or less, 7.3% or less, and particularly 7% or less.

Li₂O, Na₂O, and K₂O are components inevitably mixed from the glass raw material.

When the content of Li₂O, Na₂O, and K₂O is too large, alkali ions diffuse into a semiconductor material formed during a heat treatment step, and the device properties deteriorate. As a result, it is difficult to use it, particularly as a display substrate. On the other hand, when the content of Li₂O, Na₂O, and K₂O is too small, a raw material cost is likely to increase. Therefore, a suitable content range for Li₂O+Na₂O+K₂O, which is a total amount of Li₂O, Na₂O, and K₂O, is from 0.001% to less than 0.1%, from 0.005% to 0.09%, and particularly from 0.01% to 0.05%.

MgO is a component that enhances the HF resistance, and is also a component that decreases the viscosity in high temperature and that enhances the meltability. When the content of MgO is too small, there is a concern that the HF etching rate is increased and the taper angle of the through hole or the non-through hole is increased. In addition, the meltability is likely to decrease. In addition, the Young's modulus decreases, the glass substrate is likely to warp, and as a result, the glass substrate is likely to break. Therefore, a suitable lower limit range for MgO is 0% or more, more than 0%, 0.1% or more, 0.5% or more, 1% or more, 1.1% or more, 1.5% or more, 2% or more, 2.5% or more, 3% or more, 3.5% or more, and particularly 4% or more. On the other hand, when the content of MgO is too large, the glass is likely to undergo phase separation, and in addition, the surface roughness of the front surface of the glass after HF etching is likely to increase. In addition, devitrified crystals such as mullite are likely to precipitate, and the liquidus viscosity is likely to decrease. Therefore, a suitable upper limit range for MgO is 15% or less, 13% or less, 12.5% or less, 12.4% or less, 12% or less, 11.9% or less, 11% or less, 10% or less, 9.9% or less, 9.5% or less, and particularly 9% or less.

CaO is a component that decreases the viscosity in high temperature and that enhances the meltability. When the content of CaO is too small, it is difficult to obtain the above effects. Therefore, a lower limit range for CaO is 0% or more, more than 0%, 0.1% or more, 0.2% or more, 0.5% or more, 0.7% or more, 0.8% or more, and particularly 1% or more. On the other hand, when the content of CaO is too large, the HF etching rate is increased and the taper angle of the through hole or the non-through hole is likely to increase. In addition, the glass is likely to undergo phase separation, and in addition, the surface roughness of the front surface of the glass after HF etching is likely to increase. In addition, the amount of residues generated during etching increases, and the residues are likely to accumulate inside the holes. As a result, the hole shape is likely to vary. Further, residue clogging is likely to occur in the etching device, and the load in treating the residues is increased. The mass of the residues generated at this time is proportional to the formula weight of the salt composed of the alkaline earth metal, Al, and F, so that the larger the atomic weight of the alkaline earth element, the more likely this problem is apparent. In particular, when forming the through hole by etching, a residue equivalent to the volume of the through hole is generated in addition to a reduction in thickness of the glass substrate. In the case of providing a large number of through holes, the residues are generated in proportion to the number of through holes, and therefore even for a glass substrate that has no problems in slimming processes in the related art, the above problems become apparent, resulting in an increase in manufacturing cost. Therefore, a suitable upper limit range for CaO is 15% or less, 12.5% or less, 10.1% or less, 10% or less, 8.5% or less, 8.2% or less, 8% or less, 7.5% or less, 7.2% or less, 7.1% or less, 7% or less, 6.8% or less, 6.5% or less, 6% or less, 5.5% or less, 5.4% or less, 5.3% or less, 5% or less, 4.9% or less, 4.5% or less, and particularly 4% or less. In particular, in the case where the content of CaO is 7% or less, the above problems caused by the residues are easily solved.

SrO is a component that decreases the viscosity in high temperature and that enhances the meltability. When the content of SrO is too small, it is difficult to obtain the above effects. Therefore, a suitable lower limit range for SrO is 0% or more, more than 0%, 0.1% or more, 0.2% or more, 0.5% or more, 0.6% or more, 0.7% or more, 0.8% or more, 0.9% or more, 1% or more, 1.5% or more, 1.6% or more, 2% or more, 2.2% or more, 2.4% or more, and particularly 2.5% or more. On the other hand, when the content of SrO is too large, the HF etching rate is increased and the taper angle of the through hole or the non-through hole is likely to increase. In addition, the amount of residues increases, and the hole shape is likely to vary. Therefore, a suitable upper limit range for SrO is 15% or less, 12.5% or less, 12% or less, 10% or less, 9% or less, 8% or less, 7.6% or less, 7.5% or less, 7% or less, 6.5% or less, and particularly 6% or less.

BaO is a component that enhances the devitrification resistance, and is a component that makes it difficult for the glass to undergo phase separation. When the content of BaO is too small, it is difficult to obtain the above effects. Therefore, a suitable lower limit range for BaO is 0% or more, more than 0%, 0.01% or more, more than 0.01%, 0.02% or more, 0.03% or more, 0.05% or more, 0.08% or more, 0.1% or more, and particularly 0.15% or more. On the other hand, when the content of BaO is too large, the HF etching rate is likely to increase and the taper angle of the through hole or the non-through hole is likely to increase. In addition, the mass of the residues increases, which causes the problems described above due to the residues, the hole shape is likely to vary, and the manufacturing cost is increased. Therefore, a suitable upper limit range for BaO is 2.9% or less, 2.5% or less, 2% or less, 1% or less, 0.95% or less, 0.9% or less, 0.88% or less, 0.86% or less, 0.85% or less, 0.84% or less, 0.82% or less, 0.8% or less, 0.75% or less, 0.7% or less, 0.5% or less, 0.4% or less, 0.3% or less, and particularly 0.2% or less.

When MgO+CaO+SrO+BaO, which is the total amount of MgO, CaO, SrO, and BaO, is too small, there is a concern that the meltability decreases. Therefore, a suitable lower limit range for MgO+CaO+SrO+BaO is 1% or more, 2% or more, 3% or more, 4% or more, 4.5% or more, 5% or more, 5.5% or more, 6% or more, 6.5% or more, 7% or more, 7.5% or more, and particularly 8% or more. On the other hand, when MgO+CaO+SrO+BaO is too large, there is a concern that the HF etching rate is increased and the taper angle of the through hole or the non-through hole is increased. In addition, etching residues are likely to be generated, and the manufacturing cost is increased. Therefore, a suitable upper limit range for MgO+CaO+SrO+BaO is 20% or less, 17% or less, 16.8% or less, 16.5% or less, 16% or less, 15.5% or less, 15% or less, 14.8% or less, 14.5% or less, 14% or less, 13.5% or less, 13% or less, 12.5% or less, 12.4% or less, 12% or less, 11.5% or less, 11% or less, 10% or less, and particularly 9.9% or less.

A molar ratio MgO/(MgO+CaO+SrO+BaO) is an important component ratio for achieving the reduction of the taper angle of the through hole or the non-through hole, the devitrification resistance, and the Young's modulus. When MgO/(MgO+CaO+SrO+BaO) is too small, the HF etching rate is likely to increase and the taper angle of the through hole or the non-through hole is likely to increase. In addition, there is a concern that the Young's modulus decreases. Therefore, a suitable lower limit range for MgO/(MgO+CaO+SrO+BaO) is 0 or more, 0.05 or more, 0.1 or more, 0.15 or more, 0.2 or more, 0.25 or more, 0.3 or more, 0.33 or more, 0.35 or more, 0.38 or more, and particularly 0.4 or more. In addition, when MgO/(MgO+CaO+SrO+BaO) is too large, the glass is likely to undergo phase separation, the HF etching rate is increased, and the taper angle of the through hole or the non-through hole is likely to increase. In addition, devitrified crystals such as mullite are likely to precipitate, and the liquidus viscosity is likely to decrease. Therefore, a suitable upper limit range for MgO/(MgO+CaO+SrO+BaO) is 1 or less, 0.95 or less, 0.9 or less, 0.87 or less, 0.86 or less, 0.85 or less, 0.83 or less, and particularly 0.8 or less.

A molar ratio CaO/(MgO+CaO+SrO+BaO) is an important component ratio for achieving the reduction of the taper angle of the through hole or the non-through hole, phase separation prevention, and hole shape control. When CaO/(MgO+CaO+SrO+BaO) is too large, the glass is likely to undergo phase separation, the HF etching rate is increased, and the taper angle of the through hole or the non-through hole is likely to increase. In addition, etching residues are more likely to be generated, and the hole shape is likely to vary. Therefore, a suitable upper limit range for CaO/(MgO+CaO+SrO+BaO) is 1 or less, 0.9 or less, 0.8 or less, 0.7 or less, 0.68 or less, 0.67 or less, 0.66 or less, 0.65 or less, 0.63 or less, 0.62 or less, 0.6 or less, 0.57 or less, 0.55 or less, 0.53 or less, 0.51 or less, 0.5 or less, 0.45 or less, 0.42 or less, and particularly 0.4 or less. In addition, when CaO/(MgO+CaO+SrO+BaO) is too small, the viscosity in high temperature is increased, and the meltability decreases. Therefore, a suitable lower limit range for CaO/(MgO+CaO+SrO+BaO) is 0 or more, 0.01 or more, 0.03 or more, 0.05 or more, 0.08 or more, and particularly 0.1 or more.

A molar ratio SrO/(MgO+CaO+SrO+BaO) is an important component ratio for achieving both liquidus temperature and phase separation prevention. When SrO/(MgO+CaO+SrO+BaO) is too small, the liquidus temperature is increased, and the liquidus viscosity is likely to decrease. In addition, the glass is likely to undergo phase separation. Therefore, a suitable lower limit range for SrO/(MgO+CaO+SrO+BaO) is 0 or more, 0.01 or more, 0.05 or more, 0.08 or more, 0.1 or more, 0.14 or more, 0.15 or more, 0.16 or more, 0.18 or more, 0.2 or more, 0.23 or more, and particularly 0.25 or more. In addition, when SrO/(MgO+CaO+SrO+BaO) is too large, the HF etching rate is increased and the taper angle of the through hole or the non-through hole is likely to increase. In addition, etching residues are more likely to be generated, and the manufacturing cost is increased. Therefore, a suitable upper limit range for SrO/(MgO+CaO+SrO+BaO) is 1 or less, 0.99 or less, 0.9 or less, 0.85 or less, 0.8 or less, 0.75 or less, 0.7 or less, 0.68 or less, 0.67 or less, 0.66 or less, 0.65 or less, 0.63 or less, 0.62 or less, 0.6 or less, 0.57 or less, and particularly 0.55 or less.

A molar ratio BaO/(MgO+CaO+SrO+BaO) is an important component ratio for controlling the etching rate. When the molar ratio BaO/(MgO+CaO+SrO+BaO) is reduced, in particular, the HF etching rate may be reduced, and the taper angle of the through hole or the non-through hole is likely to reduce. In addition, the viscosity in high temperature may be decreased and the meltability may be enhanced. Therefore, a suitable range for BaO/(MgO+CaO+SrO+BaO) is from 0 to 0.2, from 0 to 0.15, from 0 to 0.1, from 0 to 0.08, from 0 to 0.06, from 0 to 0.05, from 0 to 0.04, from 0 to 0.03, from 0 to 0.02, and particularly from 0 to 0.01.

SnO₂ is a component having a good fining action in a high temperature range, and is a component that decreases the viscosity in high temperature and that enhances the meltability. It is also a component that is mixed in from electrodes used during electric melting in a glass manufacturing kiln. The environmental load can be reduced by using an electric melting furnace instead of a burning furnace in glass melting. Therefore, in order to produce glass substrates at a high yield or to reduce the environmental load in manufacturing the glass substrates, SnO₂ is preferably contained. Therefore, a suitable lower limit range for SnO₂ is 0 or more, 0.01 or more, and particularly 0.05 or more. When the content of SnO₂ is small than 0.05%, it is difficult to obtain the above effects. On the other hand, when the content of SnO₂ is too large, devitrified crystals of SnO₂ are likely to precipitate, and thus there is a concern that the yield decreases.

Therefore, a suitable upper limit range for SnO₂ is 1 or less, 0.8 or less, and particularly preferably 0.5% or less.

As described above, SnO₂ is suitable as a fining agent. However, as long as the glass properties are not impaired, F, SO₃, C, or a metal powder such as Al or Si may be added up to 1% for each (preferably up to 0.8%, particularly preferably up to 0.5%), instead of SnO₂ or together with SnO₂, as fining agents. In addition, CeO₂ can also be added as a fining agent, but when a content of CeO₂ is too large, the glass is colored. Therefore, an upper limit of the content thereof is preferably 0.1%, more preferably 0.05%, and particularly preferably 0.01%.

As₂O₃ and Sb₂O₃ are also effective components as fining agents. However, As₂O₃ and Sb₂O₃ are also components that increase the environmental load. Therefore, it is preferable that the glass substrate according to the present invention does not substantially contain As₂O₃ and Sb₂O₃, and even they are contained, the content is preferably in a range of from 0% to less than 0.05%.

TiO₂ is a component that decreases the viscosity in high temperature and that enhances the meltability, and is also component that increases an absorbance in an ultraviolet region. When the absorbance in the ultraviolet region, particularly the absorbance in a deep ultraviolet region, is high, multiphoton absorption is likely to occur when irradiated with a femtosecond or picosecond laser, making it easier to prepare a modified portion in the glass. Therefore, in the case of preparing a laser modified portion in the glass substrate and then removing the modified portion by etching to form a through hole in the glass substrate, the incorporation of TiO₂ is advantageous. Therefore, a suitable lower limit range for TiO₂ is 0% or more, 0.0005% or more, 0.001% or more, and particularly 0.005% or more. On the other hand, when a large amount of TiO₂ is contained, there is a concern that the glass substrate is colored, and the transmittance of the glass substrate decreases. Therefore, in the case of using the glass substrate as a display application, a suitable upper limit range for TiO₂ is 0.1% or less, less than 0.1%, 0.08% or less, and particularly 0.05% or less.

ZnO is a component that enhances the meltability. However, when a large amount of ZnO is contained, the glass substrate is colored, and the transmittance of the glass substrate is likely to decrease. Therefore, in the case of using the glass substrate as a display application, the content of ZnO is preferably small, and the content is preferably from 0% to 4%, more preferably from 0% to 3%, from 0% to 2%, from 0% to 1%, from 0% to 0.5%, from 0% to 0.4%, from 0% to 0.3%, from 0% to 0.2%, and particularly preferably from 0% to 0.1%.

MoO₃ is a component that may be mixed in from electrodes used during electric melting in a glass manufacturing kiln. Since the environmental load can be reduced by using an electric melting furnace instead of a burning furnace in glass melting, it is preferable that the glass contains a small amount of MoO₃. When the content of MoO₃ is too large, the glass is likely to be colored. On the other hand, when the content of MoO₃ is to be reduced, the melting temperature needs to be lowered, and in this case, it is difficult to melt the glass. Therefore, the content of MoO₃ is preferably from 0% to 0.4%, more preferably from 0% to 0.1%, from 0.0001% to 0.05%, from 0.0005% to 0.01%, from 0.0008% to 0.008%, from 0.0008% to 0.005%, and particularly preferably from 0.001% to 0.005%.

In addition to the above components, the following components may be added as an optional component, for example. Note that, a total content of components other than the above components is preferably 5% or less, 1% or less, and particularly preferably 0.1% or less, from the viewpoint of accurately achieving the effects of the present invention.

P₂O₅ is a component that enhances the HF resistance. However, when a large amount of P₂O₅ is contained, the glass is likely to undergo phase separation. Therefore, the content of P₂O₅ is preferably from 0% to 2.5%, from 0.0005% to 1.5%, from 0.001% to 0.5%, and particularly preferably from 0.005% to 0.3%.

CuO is a component that colors the glass. Therefore, in the case of using the glass substrate as a display application, a content of CuO is preferably small, and the content is preferably from 0% to 0.1%, more preferably from 0% to less than 0.1%, and particularly preferably from 0% to 0.05%.

Y₂O₃, Nb₂O₅, and La₂O₃ are components that enhance mechanical properties such as Young's modulus. When a total amount or individual content of these components is too large, the raw material cost is likely to increase. Therefore, the total amount and individual content of

Y₂O₃, Nb₂O₅, and La₂O₃ are preferably from 0% to 5%, more preferably from 0% to 1%, from 0% to 0.5%, and particularly preferably from 0% to less than 0.5%.

Fe₂O₃ is a component that may be mixed in from the glass raw material and is also a component that colors the glass. When a raw material having a high purity is used to reduce a content of Fe₂O₃, the raw material cost is likely to increase. On the other hand, when the content of Fe₂O₃ is too large, the glass substrate is colored, making it difficult to use for a display application. A suitable content range for Fe₂O₃ is from 0% to 0.05%, from 0.0005% to 0.03%, and particularly from 0.001% to 0.02%.

ZrO₂ is a component that may be mixed in from a refractory used in a glass manufacturing kiln. When the content of ZrO₂ is too large, devitrified crystals are likely to precipitate. On the other hand, when the content of ZrO₂ is to be reduced, the melting temperature needs to be lowered, and in this case, it is difficult to melt the glass. Therefore, a suitable content range for ZrO₂ is from 0% to 0.5%, from 0.0001% to 0.5%, from 0.001% to 0.4%, and particularly from 0.005% to 0.3%.

Cl is a component that facilitates initial melting of a glass batch. In addition, the addition of Cl can facilitate the action of the fining agent. As a result, it is possible to extend the life of the glass manufacturing kiln while reducing the melting cost. However, when the content of Cl is too large, the strain point is likely to decrease, and in the case of being used for a display application, there is a concern that total pitch deviation occurs. Therefore, a suitable content range for the content of Cl is from 0% to 3%, from 0.0005% to 1%, and particularly from 0.001% to 0.5%. Note that, as a raw material for introducing Cl, a raw material such as a chloride of an alkaline earth metal oxide, an example being strontium chloride, or aluminum chloride can be used.

The glass substrate according to the present invention preferably has the following properties.

In the glass substrate according to the present invention, the HF etching rate is preferably 2.00 μm/min or less, 1.50 μm/min or less, 1.00 μm/min or less, 0.75 μm/min or less, 0.70 μm/min or less, 0.65 μm/min or less, 0.60 μm/min or less, 0.55 μm/min or less, and particularly preferably 0.50 μm/min or less. With such an etching rate, the opening diameter is less likely to increase in preparing the hole in the main surface of the glass substrate, and therefore the taper angle can be reduced. As a result, holes can be prepared in the glass substrate at a high density.

In the glass substrate according to the present invention, an average thermal expansion coefficient in a temperature range of from 30° C. to 380° C. is preferably from 30×10⁻⁷/° C. to 50×10⁻⁷/° C., from 32×10⁻⁷/° C. to 48×10⁻⁷/° C., from 33×10⁻⁷/° C. to 45×10⁻⁷/° C., from 34×10⁻⁷/° C. to 44×10⁻⁷/° C., and particularly preferably from 35×10⁻⁷/° C. to 43×10⁻⁷/° C. This makes it easy to match the thermal expansion coefficient of Si used in TFT.

In the glass substrate according to the present invention, the Young's modulus preferably 65 GPa or more, 70 GPa or more, 75 GPa or more, 77 GPa or more, 78 GPa or more, and particularly preferably 80 GPa or more. When the Young's modulus is too small, there is a concern that defects due to warping of the glass substrate are generated.

In the glass substrate according to the present invention, the strain point is preferably 650° C. or higher, 680° C. or higher, higher than 686° C., and particularly preferably 690° C. or higher. This makes it possible to reduce thermal shrinkage of the glass substrate in a TFT manufacturing process.

In the glass substrate according to the present invention, the liquidus temperature is preferably 1350° C. or lower, lower than 1350° C., 1325° C. or lower, 1300° C. or lower, and particularly preferably from 1000° C. to 1280° C. This makes it easy to prevent a situation where devitrified crystals are formed during forming to decrease the productivity. Further, the glass substrate can be easily formed by using an overflow down-draw method, and thus the surface quality of the glass substrate is likely to be enhanced and the manufacturing cost of the glass substrate can be reduced. Note that, the liquidus temperature is an index of the devitrification resistance, and the lower the liquidus temperature is, the more excellent the devitrification resistance is.

In the glass substrate according to the present invention, the liquidus viscosity is preferably 10^{4.0} dPa·s or more, 10^{4.1} dPa·s or more, 10^{4.2} dPa·s or more, and particularly preferably 10^{4.3} dPa·s or more. With such a liquidus viscosity, devitrification is less likely to occur during forming, and thus the glass substrate is easily formed by using the overflow down-draw method. As a result, the surface quality of the glass substrate can be enhanced, and the manufacturing cost of the glass substrate can be reduced. Note that, the liquidus viscosity is an index of the devitrification resistance and the formability, and the higher the liquidus viscosity is, the higher the devitrification resistance and the formability are.

In the glass substrate according to the present invention, a temperature at a viscosity in high temperature of 10^{2.5} dPa·s is preferably 1750° C. or lower, 1725° C. or lower, 1700° C. or lower, 1690° C. or lower, 1680° C. or lower, and particularly preferably from 1400° C. to 1670° C. When the temperature at a viscosity in high temperature of 10^{2.5} dPa·s is too high, it is difficult to melt the glass batch, and the manufacturing cost of the glass substrate is increased. Note that, the temperature at a viscosity in high temperature of 10^{2.5} dPa·s corresponds to the melting temperature, and the lower the temperature is, the better the meltability is.

The glass substrate according to the present invention preferably does not undergo phase separation. The presence or absence of phase separation can be checked by measuring a linear transmittance at a wavelength of 450 nm through a glass substrate having a thickness of 1 mm. In the case where the transmittance is 89.5% or more, it can be determined that the glass substrate does not undergo phase separation. When the glass substrate undergoes phase separation, the transmittance decreases, making it difficult to use the glass substrate for a display application. In addition, unevenness is likely to occur on the front surface of the glass during HF etching, a surface roughness Sa on the front surface of the glass substrate is likely to increase, and it is difficult to form a film during manufacturing of a display. In particular, in the case where the glass substrate according to the present invention is used as a micro LED display application, since a typical emission wavelength of a blue LED is about 450 nm, a high transmittance at this wavelength is required. Note that, when phase separation of several tens of nanometers occurs inside the glass, the transmittance in ultraviolet to blue regions decreases due to Rayleigh scattering. Therefore, the linear transmittance at a wavelength of 450 nm in a glass substrate having a thickness of 1 mm is preferably 89.5% or more, 89.6% or more, 89.7% or more, 89.8% or more, 89.9% or more, 90.0% or more, 90.1% or more, 90.2% or more, 90.3% or more, 90.4% or more, and particularly preferably 90.5% or more. Note that, the presence or absence of the phase separation may be determined based on scattered light measurement or checking of the presence or absence of white turbidity by visual observation.

A suitable upper limit range for the surface roughness Sa on the front surface of the glass substrate is 4.5 nm or less, 4 nm or less, 3.5 nm or less, 3 nm or less, 2 nm or less, 1.5 nm or less, 1.4 nm or less, 1.3 nm or less, 1.2 nm or less, 1.1 nm or less, 1 nm or less, 0.9 nm or less, 0.8 nm or less, 0.7 nm or less, 0.6 nm or less, and particularly 0.5 nm or less. Within such a range, the reliability is enhanced when a TFT is prepared on the glass substrate for use in a display application. In addition, a suitable lower limit range for the surface roughness Sa of the glass substrate is 0.05 nm or more, 0.075 nm or more, 0.1 nm or more, 0.125 nm or more, 0.15 nm or more, and particularly 0.2 nm or more. Within such a range, when a plating film is prepared on the front surface of a glass substrate to prepare a wiring portion on the glass substrate, the adhesion of the plating film to the glass substrate is improved due to an anchor effect.

In addition, the surface roughness Sa on the front surface of the glass substrate increases due to etching, but it is preferable that the surface roughness Sa on the front surface of the glass substrate immediately after the glass substrate is etched is within the suitable range described above. When the surface roughness Sa after etching is too large, an additional polishing step is required to perform film formation or the like, and there is a concern that the manufacturing cost is increased. In particular, when forming the through hole by etching, this problem is likely to be avoided by selecting a glass composition that is less likely to increase the surface roughness due to etching.

The surface roughness Sa on the front surface of the glass substrate is a surface roughness based on ISO 25178, and can be measured using an AFM (for example, Dimension Icon, manufactured by Bruker Corporation), a white light interferometer (for example, NewView 7300, manufactured by Zygo Corporation), or a laser microscope (for example, VK-X250, manufactured by Keyence Corporation).

A β-OH value is an index that indicates the amount of water in the glass, and, when the β-OH value is decreased, the strain point can be increased. Even when the glass compositions are the same, the smaller the β-OH value is, the smaller the thermal shrinkage at a temperature equal to or lower than the strain point is. The β-OH value is preferably 0.35/mm or less, 0.30/mm or less, more preferably 0.28/mm or less, 0.25/mm or less, and particularly preferably 0.20/mm or less. Note that, when the β-OH value is too small, the meltability is likely to decrease. Therefore, the β-OH value is preferably 0.01/mm or more, and particularly preferably 0.03/mm or more.

Examples of a method for decreasing the β-OH value include the following. (1) Selecting a raw material having a low water content. (2) Adding a component (Cl, SO₃ or the like) for decreasing the β-OH value to the glass. (3) Decreasing the amount of water in a furnace atmosphere. (4) Performing N₂ bubbling in the molten glass. (5) Adopting a small melting furnace. (6) Increasing a flow rate of the molten glass. (7) Adopting an electric melting method.

Here, the “β-OH value” refers to a value obtained by substituting the transmittance of the glass measured by using FT-IR according to the following Equation 1.

$$β - OH value = ( 1 / X ) log ( {T}_{1} / {T}_{2} ) \qquad Equation 1$$

X: thickness (mm)
T₁: transmittance (%) at a reference wavelength of 3846 cm⁻¹
T₂: minimum transmittance (%) near an absorption wavelength of hydroxy groups of 3600 cm⁻¹

The glass substrate according to the present invention is preferably formed by using the overflow down-draw method. The overflow down-draw method is a method for manufacturing a glass substrate by causing the molten glass to overflow from both sides of a heat-resistant forming structure, and drawing and forming the overflowing molten glass downward while joining the overflowing molten glass at a lower end of the forming structure. In the overflow down-draw method, the surface to be the surface of the glass substrate does not come into contact with the forming refractory and is formed in a free surface state. Therefore, it is possible to inexpensively manufacture an unpolished glass substrate with good surface quality, and it is also easy to reduce the thickness thereof.

In addition to the overflow down-draw method, the glass substrate can also be formed by, for example, a down-draw method (such as a slot-down method) or a float method.

In the glass substrate according to the present invention, the thickness is not particularly limited, and is preferably 2.0 mm or less, 1.5 mm or less, 1 mm or less, 0.7 mm or less, less than 0.7 mm, 0.6 mm or less, less than 0.6 mm, and particularly preferably from 0.05 mm to 0.5 mm. The thinner the thickness is, the smaller the opening diameter of the through hole can be. As a result, through holes can be prepared at a high density. Note that, the thickness can be adjusted by a flow rate, a sheet pulling speed, and the like during forming.

The glass substrate according to the present invention preferably has a hole, and preferably particularly has a through hole, in the main surface. It preferably has a plurality of through holes. This makes it easy to use the glass substrate as a substrate in a glass interposer or a micro LED display, particularly a tiling type micro LED display.

The glass substrate according to the present invention is preferably provided with a through hole or a non-through hole by using the following method.

Known methods for forming the through hole or the non-through hole include a method using laser ablation and a method in which a modified portion is prepared by irradiating the glass with a laser and then removing the modified portion by etching to form a through hole or a non-through hole. In the method of removing the modified portion by etching, the time required for etching does not change even when the number of holes is increased, so that the productivity of holes is high. In the case of using a glass substrate formed with through holes in an interposer or a micro LED display, it is necessary to form many through holes on the substrate, so that the most preferred method is to form the through holes by removing the modified portion by etching.

The modified portion can be formed by irradiating the glass substrate with a femtosecond or picosecond pulse laser. The beam shape of the laser used to prepare the modified portion is preferably a Gaussian beam shape or a Bessel beam shape, and particularly preferably a Bessel beam shape. In the case of a Bessel beam shape, the modified portion can be formed to penetrate the thickness direction in one shot, thereby shortening the time required to form the modified portion. The Bessel beam shape can be formed, for example, by using an axicon lens.

The type of an etching solution used for etching is not particularly limited as long as it has a faster etching rate for the modified portion than for the glass substrate, and for example, HF or KOH is preferred. As the etching solution, HF is particularly preferred since it has a high etching rate and can enhance the productivity of through holes. In addition, one or more acids such as HCl, H₂SO₄, and HNO₃ may be added to the HF solution to prepare a mixed solution. With such a mixed solution, adhesion of residues to the front surface of the glass and inner walls of the holes is likely to be reduced.

A temperature of the etching solution is not particularly limited, and the taper angle of the through hole or the non-through hole can be controlled by controlling the temperature. When the temperature of the etching solution is lowered, the amount of residues generated per unit time is reduced, it is difficult for the residues to accumulate inside the through hole or the non-through hole, etching in a direction in which the through hole or the non-through hole grows is less likely to be hindered, and the taper angle is less likely to increase. As a result, the taper angle of the through hole or the non-through hole can be reduced. On the other hand, when the temperature of the etching solution is increased, the etching rate is increased, and the productivity of holes can be enhanced. However, the amount of residues generated per unit time increases, the etching in the direction in which the through hole or the non-through hole grows is likely to be hindered, and the taper angle is likely to increase. Further, HF is likely to be volatilized in the etching solution, causing unevenness in the HF concentration and increasing the variation in hole shape. Therefore, in the case of an etching solution containing HF, the temperature range is preferably from 0° C. to 50° C., from 0° C. to 40° C., and particularly preferably from 5° C. to 25° C.

It is preferable to stir the etching solution or apply ultrasonic waves to the etching solution during etching. In particular, application of ultrasonic waves can prevent adhesion and redeposition of residues to the inner walls of holes. A frequency of the ultrasonic waves is preferably 100 kHz or less, 45 kHz or less, and particularly preferably 30 kHz or less. Accordingly, the effect of ultrasonic cavitation can be enhanced.

The glass substrate according to the present invention obtained by the above steps has the following properties.

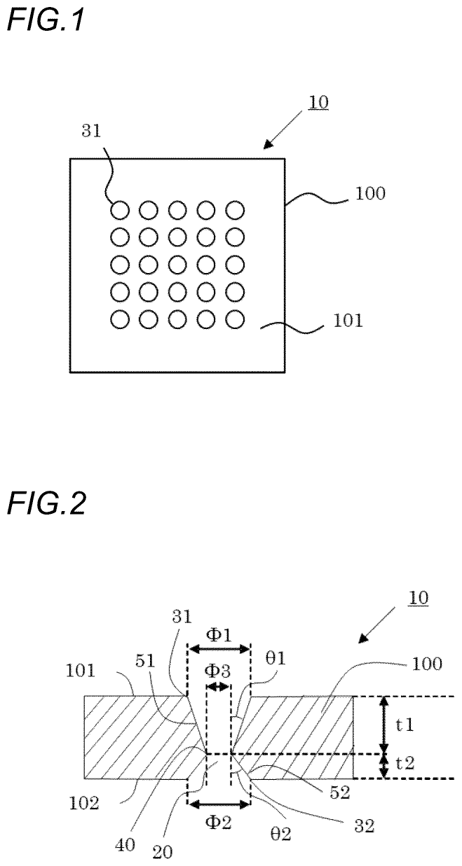

FIG. 1 is a schematic plane diagram of a glass substrate having through holes according to the present invention. As shown in FIG. 1, a glass substrate with holes 10 has openings 31 of a plurality of through holes 20 in a first surface 101 of a glass substrate 100 that is rectangular in a plan view.

The taper angle of the through hole in the glass substrate according to the present invention is evaluated by using the following method. FIG. 2 is a schematic cross-sectional view showing the glass substrate with holes 10 manufactured according to one embodiment of the present invention. Note that, FIG. 2 is an enlarged cross-sectional view focusing on one of the plurality of through holes formed in the glass substrate with holes 10. As shown in FIG. 2, the glass substrate with holes 10 includes the glass substrate 100 and the through hole 20. The glass substrate 100 is typically a sheet-shaped glass member, and has the first surface 101 and a second surface 102 as front and back main surfaces. The through hole 20 is a hole formed to penetrate the glass substrate 100 from the first surface 101 to the second surface 102. The through hole 20 has the opening 31 in the first surface 101 and an opening 32 in the second surface 102. In addition, an inner surface of the through hole 20 has a tapered shape. Further, the through hole 20 has therein a narrowed portion 40 where a hole diameter is the smallest. More specifically, the through hole 20 has a first tapered portion 51 that gradually narrows from the opening 31 to the narrowed portion 40, and a second tapered portion 52 that gradually narrows from the opening 32 to the narrowed portion 40. That is, the through hole 20 has therein a gently constricted hourglass-like double tapered shape. The narrowed portion 40 is a portion where an inner diameter of the through hole 20 is the smallest. Note that, an opening diameter (diameter) of the opening 31 is Φ1, an opening diameter (diameter) of the opening 32 is Φ2, and an inner diameter (diameter) of the narrowed portion 40 is Φ3. A hole depth of the first tapered portion 51 is t1, and a hole depth of the second tapered portion 52 is t2.

In FIG. 2, an average taper angle θ of the through hole 20 is a value calculated according to the following Equation 2.

$$θ = ( θ 1 + θ2 ) / 2 \qquad Equation 2$$

The taper angles θ1 and θ2 can be calculated according to the following Equations 3 and 4.

$$θ 1 = arctan ( ( Φ 1 - Φ3 ) / ( 2 * t 1 ) ) \qquad Equation 3$$

$$θ2 = arctan ( ( Φ2 - Φ3 ) / ( 2 * t 2 ) ) \qquad Equation 4$$

The values necessary for calculating the average taper angle θ can be measured by using the following method. The opening diameters Φ1 and Φ2 of the first surface 101 and the second surface 102 can be measured, for example, by observing the surface of the glass substrate with a transmission optical microscope (for example, ECLIPSE LV100ND manufactured by Nikon Corporation) and measuring the diameters based on an image. The inner diameter Φ3 of the narrowed portion 40 of the through hole 20, the distance t1 from the first surface 101 to the narrowed portion 40, and the distance t2 from the second surface 102 to the narrowed portion 40 can be measured by observing the through hole 20 from a cross-sectional direction, adjusting the focus by moving the focus inside the glass, and measuring the distances based on the image. At this time, it is preferable to scribe the glass substrate 100 such that the through hole 20 is not exposed on the cross section, and then bend and break the glass substrate 100 to obtain the cross section.

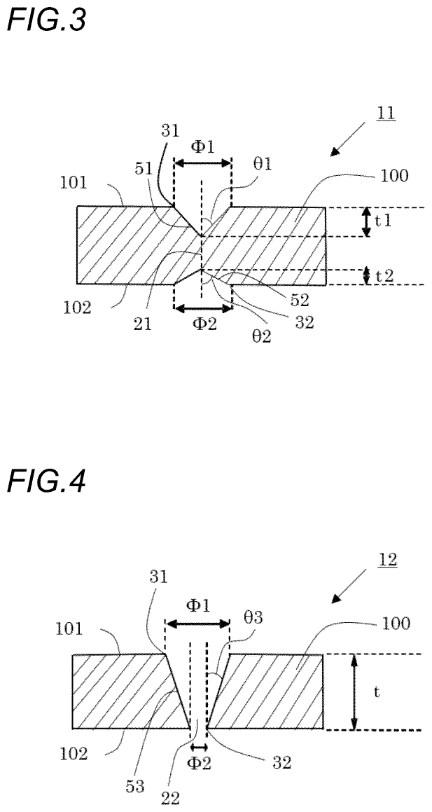

FIG. 3 is a schematic cross-sectional view of a glass substrate with holes 11 having a non-through hole 21. The glass substrate with holes 11 having the non-through hole is obtained, for example, by interrupting an etching treatment in a stage before the non-through hole 21 penetrates the glass substrate 100 in an etching step (before the through hole 20 is formed).

The taper angles θ1 and Φ2 of the non-through hole 21 can be calculated according to the following Equations 5 and 6. The average taper angle θ can be calculated using the taper angles θ1 and Φ2 and the Equation 1.

$$θ 1 = arctan ( Φ1 / ( 2 * t 1 ) ) \qquad Equation 5$$

$$θ2 = arctan ( Φ2 / ( 2 * t 2 ) ) \qquad Equation 6$$

The opening diameters Φ1 and Φ2 and the hole depths t1 and t2 in the first surface 101 and the second surface 102 can be measured based on an image obtained using a transmission optical microscope, in the same manner as in the case of a through hole.

In a glass with holes according to the present invention, the through hole may not have the narrowed portion. FIG. 4 is a schematic cross-sectional view of a glass substrate with holes 12 including a tapered portion 53 and a through hole 22 having no narrowed portion inside the glass. The glass with holes 12 is obtained, for example, by bonding a carrier substrate to one main surface of a glass substrate in an etching step and etching the glass substrate from a surface facing the bonded main surface.

A taper angle θ3 (that is, the average taper angle θ) of the through hole 22 having no narrowed portion is defined as a value calculated according to Equation 7. The opening diameters Φ1 and Φ2 and a thickness t in the first surface 101 and the second surface 102 can be measured based on an image obtained using a transmission optical microscope, in the same manner as in the above case.

$$θ 3 = arctan ( ( Φ1 - Φ2 ) / ( 2 * t ) ) \qquad Equation 7$$

For the average taper angle of the through hole or the non-through hole in the glass substrate according to the present invention, a suitable upper limit range is 13° or less, 12° or less, 11.5° or less, 11° or less, 10° or less, 9.0° or less, 8.1° or less, 8.0° or less, 7.5° or less, 7.0° or less, 6.5° or less, and particularly 6.0° or less. When the taper angle is too large, it is difficult to form the through hole or the non-through hole at a high density. As a result, it is difficult to mount semiconductors on the glass substrate at a high density. In addition, a suitable lower limit range for the average taper angle is 0° or more, 1.0° or more, 1.5° or more, 2.0° or more, 2.5° or more, 3.0° or more, 3.5° or more, and particularly 4.0° or more. When the taper angle is too small, in a plating step of forming a conductive portion on the inner wall of the through hole, it is difficult to form a film up to a deep position of the through hole in preparing a seed layer by sputtering.

For the opening diameters Φ1 and Φ2 in the main surface of the glass substrate, a suitable upper limit range is 100 μm or less, 90 μm or less, 80 μm or less, 70 μm or less, 65 μm or less, 60 μm or less, 55 μm or less, 50 μm or less, 45 μm or less, 40 μm or less, 35 μm or less, and particularly 30 μm or less. When the opening diameter is too large, holes cannot be formed at a high density on the glass with holes, and it is difficult to increase a pixel density of a display. On the other hand, when the opening diameter is too small, it is difficult to fill the inside of the hole with plating. Therefore, a suitable lower limit range for the opening diameter is 1 μm or more, 5 μm or more, 10 μm or more, and particularly 15 μm or more.

For the inner diameter Φ3 of the narrowed portion 40 of the through hole 20 in the glass substrate with holes 10, a suitable upper limit range is 100 μm or less, 90 μm or less, 80 μm or less, 70 μm or less, 60 μm or less, 50 μm or less, 45 μm or less, 40 μm or less, 35 μm or less, 30 μm or less, 25 μm or less, and particularly 20 μm or less. When the inner diameter Φ3 is too large, the opening diameters Φ1 and Φ2 increase in the main surface of the glass substrate, so that it is difficult to form a plurality of holes at a high density in the main surface of the glass substrate, and it is difficult to increase the pixel density of the display. On the other hand, when the inner diameter of the narrowed portion is too small, the resistance at the narrowed portion increases when the inside of the through hole is filled with the plating and then energized, and the generated heat is increased, so that the glass substrate is likely to be damaged due to a difference in thermal expansion between the glass substrate and the wiring portion. Therefore, a suitable lower limit range for the inner diameter Φ3 is 0.5 μm or more, 0.8 μm or more, 1 μm or more, 1.5 μm, and particularly 2 μm or more.

A suitable upper limit range for a center-to-center distance between the through holes is 200 μm or less, 160 μm or less, and particularly 100 μm or less. When the center-to-center distance between the through holes is too large, it is difficult to form the through hole at a high density. As a result, it is difficult to mount semiconductors on the glass substrate at a high density. In addition, a suitable lower limit range for the center-to-center distance between the through holes is 1.1 times or more, 1.3 times or more, 1.5 times or more, 1.7 times or more, and particularly 2.0 times or more of the opening diameter. When the center-to-center distance between the through holes is too small, a distance between hole ends of the through holes is shorter, and the glass substrate is likely to be damaged from the hole ends.

The glass substrate according to the present invention is preferably used as a substrate in a micro LED display, particularly a tiling type micro LED display. In the tiling type micro LED display, a light emitting element on the front surface of the glass can be driven from the back surface of the glass by establishing electrical continuity between the front and back surfaces of the glass substrate through the through holes. In the glass substrate according to the present invention, since the through holes can be prepared at a high density, the tiling type micro LED display can be made to have a higher definition.

### EXAMPLES

Hereinafter, the present invention will be described based on Examples. Note that, the following Examples are merely illustrative. The present invention is not limited to the following Examples in any way.

### Example 1

Tables 1 to 5 show Inventive Examples of the present invention (sample Nos. 1 to 43) and Comparative Examples (sample Nos. 44 to 46).

TABLE 1

| | | No. 1 | No. 2 | No. 3 | No. 4 | No. 5 | No. 6 |
|---|---|---|---|---|---|---|---|
| Glass | SiO₂ | 72.4 | 72.1 | 72.3 | 72.0 | 72.4 | 72.1 |
| composition | Al₂O₃ | 10.0 | 10.1 | 10.1 | 10.1 | 10.0 | 10.0 |
| (mol %) | B₂O₃ | 5.0 | 5.1 | 4.9 | 5.2 | 5.0 | 5.1 |
| | Li₂O | <0.001 | <0.001 | <0.001 | <0.001 | <0.001 | <0.001 |
| | Na₂O | 0.010 | 0.021 | 0.000 | 0.011 | 0.011 | 0.022 |
| | K₂O | 0.001 | 0.002 | 0.001 | 0.002 | 0.001 | 0.004 |
| | MgO | 7.50 | 5.05 | 5.01 | 2.56 | 2.52 | 2.52 |
| | CaO | 2.49 | 5.01 | 2.49 | 7.49 | 4.95 | 2.51 |
| | SrO | 2.49 | 2.51 | 5.04 | 2.56 | 5.03 | 7.52 |
| | BaO | 0.03 | 0.03 | 0.06 | 0.03 | 0.05 | 0.08 |
| | SnO₂ | 0.1 | 0.1 | 0.1 | 0.1 | 0.1 | 0.1 |
| | As₂O₃ | <0.01 | <0.01 | <0.01 | <0.01 | <0.01 | <0.01 |
| | Sb₂O₃ | <0.01 | <0.01 | <0.01 | <0.01 | <0.01 | <0.01 |
| | CuO | 0.0 | 0.0 | 0.0 | 0.0 | 0.0 | 0.0 |
| | ZnO | 0.0 | 0.0 | 0.0 | 0.0 | 0.0 | 0.0 |
| | P₂O₃ | 0.0 | 0.0 | 0.0 | 0.0 | 0.0 | 0.0 |
| | TiO₂ | 0.008 | 0.008 | 0.008 | 0.008 | 0.007 | 0.008 |
| | Fe₂O₃ | 0.007 | 0.006 | 0.006 | 0.006 | 0.006 | 0.006 |
| | ZrO₂ | 0.001 | 0.001 | 0.002 | 0.002 | 0.002 | 0.002 |
| | MoO₃ | 0.0005 | 0.0007 | <0.00003 | 0.0001 | 0.0001 | 0.0001 |
| | Cl | 0.002 | 0.002 | 0.002 | 0.002 | 0.002 | 0.002 |
| | F | <0.07 | <0.07 | <0.07 | <0.07 | <0.07 | <0.07 |

| | | | | | | |
|---|---|---|---|---|---|---|
| MgO + CaO + SrO + BaO | 12.51 | 12.60 | 12.60 | 12.64 | 12.55 | 12.63 |
| MgO/(MgO + CaO + SrO + | 0.60 | 0.40 | 0.40 | 0.20 | 0.20 | 0.20 |
| BaO) | | | | | | |
| CaO/(MgO + CaO + SrO + | 0.20 | 0.40 | 0.20 | 0.59 | 0.39 | 0.20 |
| BaO) | | | | | | |
| SrO/(MgO + CaO + SrO + | 0.20 | 0.20 | 0.40 | 0.20 | 0.40 | 0.60 |
| BaO) | | | | | | |
| BaO/(MgO + CaO + SrO + | 0.00 | 0.00 | 0.00 | 0.00 | 0.00 | 0.01 |
| BaO) | | | | | | |
| Density [g/cm³] | 2.43 | 2.44 | 2.48 | 2.45 | 2.48 | 2.52 |
| CTE [×10⁻⁷/° C.] | 30.1 | 33.1 | 34.3 | 34.7 | 35.7 | 36.8 |
| Young's modulus | 78.5 | 77.2 | 76.5 | 76.3 | 75.6 | 74.7 |
| [GPa] | | | | | | |
| Ps [° C.] | 713 | 705 | 708 | 704 | 705 | 702 |
| Ta [° C.] | 773 | 766 | 769 | 765 | 767 | 764 |
| Ts [° C.] | 1025 | 1018 | 1024 | 1018 | 1023 | 1022 |
| 10^{4.0} dPa · s [° C.] | 1378 | 1376 | 1380 | 1378 | 1375 | 1387 |
| 10^{3.0} dPa · s [° C.] | 1550 | 1549 | 1556 | 1552 | 1551 | 1563 |
| 10^{2.5} dPa · s [° C.] | 1659 | 1657 | 1667 | 1661 | 1662 | 1672 |
| TL [° C.] | 1290 | 1264 | 1250 | 1247 | 1276 | 1208 |
| Initial phase | Cri | Cri | Cri | Cri | Cri | Cri |
| Log₁₀ ηTL | 4.7 | 4.9 | 5.0 | 5.0 | 4.8 | 5.4 |
| HF etching rate | 0.52 | 0.51 | 0.50 | 0.51 | 0.51 | 0.53 |
| [μm/min] | | | | | | |
| Phase separation | ◯ | ◯ | ◯ | ◯ | ◯ | ◯ |
| Surface roughness Sa | Not | 2.985 | 1.274 | 1.071 | 0.837 | 0.997 |
| [nm] | measured | | | | | |
| β-OH [/mm] | 0.196 | 0.200 | 0.173 | 0.198 | 0.187 | 0.177 |
| Linear transmittance at | >90 | >90 | >90 | >90 | >90 | >90 |
| 450 nm [%] | | | | | | |

| | | No. 7 | No. 8 | No. 9 | No. 10 |
|---|---|---|---|---|---|
| Glass | SiO₂ | 69.9 | 69.7 | 72.5 | 72.3 |
| composition | Al₂O₃ | 15.0 | 10.0 | 10.1 | 10.0 |
| (mol %) | B₂O₃ | 2.4 | 7.6 | 4.6 | 5.0 |
| | Li₂O | <0.001 | <0.001 | <0.001 | <0.001 |
| | Na₂O | 0.011 | 0.022 | 0.010 | 0.021 |
| | K₂O | 0.003 | 0.004 | 0.003 | 0.003 |
| | MgO | 4.98 | 5.02 | 12.56 | 0.10 |
| | CaO | 2.50 | 2.54 | 0.09 | 12.40 |
| | SrO | 2.56 | 2.53 | <0.01 | 0.03 |
| | BaO | 2.57 | 2.53 | <0.004 | <0.004 |
| | SnO₂ | 0.1 | 0.1 | 0.1 | 0.1 |
| | As₂O₃ | <0.01 | <0.01 | <0.01 | <0.01 |
| | Sb₂O₃ | <0.01 | <0.01 | <0.01 | <0.01 |
| | CuO | 0.0 | 0.0 | 0.0 | 0.0 |
| | ZnO | 0.0 | 0.0 | 0.0 | 0.0 |
| | P₂O₃ | 0.0 | 0.0 | 0.0 | 0.0 |
| | TiO₂ | 0.008 | 0.008 | 0.009 | 0.008 |
| | Fe₂O₃ | 0.006 | 0.006 | 0.005 | 0.006 |
| | ZrO₂ | 0.001 | 0.001 | 0.000 | 0.000 |
| | MoO₃ | <0.00003 | 0.0001 | <0.00003 | <0.00003 |
| | Cl | 0.002 | 0.004 | 0.002 | 0.000 |
| | F | <0.07 | <0.07 | <0.07 | <0.07 |

| | | | | |
|---|---|---|---|---|
| MgO + CaO + SrO + BaO | 12.61 | 12.62 | 12.65 | 12.53 |
| MgO/(MgO + CaO + SrO + | 0.39 | 0.40 | 0.99 | 0.01 |
| BaO) | | | | |
| CaO/(MgO + CaO + SrO + | 0.20 | 0.20 | 0.01 | 0.99 |
| BaO) | | | | |
| SrO/(MgO + CaO + SrO + | 0.20 | 0.20 | 0.00 | 0.00 |
| BaO) | | | | |
| BaO/(MgO + CaO + SrO + | 0.20 | 0.20 | 0.00 | 0.00 |
| BaO) | | | | |
| Density [g/cm³] | 2.57 | 2.50 | 2.38 | 2.42 |
| CTE [×10⁻⁷/° C.] | 33.1 | 34.6 | 26.2 | 36.3 |
| Young's modulus | 83.1 | 73.8 | 81.1 | 76.3 |
| [GPa] | | | | |
| Ps [° C.] | 748 | 681 | 761 | 718 |
| Ta [° C.] | 809 | 740 | 825 | 778 |
| Ts [° C.] | 1045 | 991 | Not | 1023 |
| | | | measured | |
| 10^{4.0} dPa · s [° C.] | 1367 | 1358 | 1367 | 1364 |
| 10^{3.0} dPa · s [° C.] | 1526 | 1533 | 1532 | 1539 |
| 10^{2.5} dPa · s [° C.] | 1628 | 1657 | 1637 | 1652 |
| TL [° C.] | >1334.6 | 1156 | 1362 | 1253 |
| Initial phase | Not | Cri | Cri | Cri |
| | measured | | | |
| Log₁₀ ηTL | <4.3 | 5.6 | Not | 4.9 |
| | | | measured | |
| HF etching rate | 0.59 | 0.56 | 1.31 | 0.52 |
| [μm/min] | | | | |
| Phase separation | ◯ | ◯ | ◯ | ◯ |
| Surface roughness Sa | Not | Not | Not | Not |
| [nm] | measured | measured | measured | measured |
| β-OH [/mm] | 0.143 | 0.201 | Not | Not |
| | | | measured | measured |
| Linear transmittance at | >90 | >90 | >90 | >90 |
| 450 nm [%] | | | | |

TABLE 2

| | | No. 11 | No. 12 | No. 13 | No. 14 | No. 15 | No. 16 | No. 17 | No. 18 | No. 19 | No. 20 |
|---|---|---|---|---|---|---|---|---|---|---|---|
| Glass | SiO₂ | 71.8 | 72.2 | 72.35 | 72.2 | 72.2 | 72.3 | 71.9 | 72.2 | 72.15 | 71.9 |
| composition | Al₂O₃ | 10.0 | 10.1 | 10.0 | 10.1 | 10.0 | 10.1 | 10.0 | 10.0 | 10.0 | 10.1 |
| (mol %) | B₂O₃ | 5.3 | 4.9 | 4.8 | 4.9 | 4.9 | 4.9 | 5.1 | 5.1 | 5.0 | 5.2 |
| | Li₂O | <0.001 | <0.001 | <0.001 | <0.001 | <0.001 | <0.001 | <0.001 | <0.001 | <0.001 | <0.001 |
| | Na₂O | 0.011 | 0.010 | 0.010 | 0.010 | 0.011 | 0.010 | 0.011 | 0.010 | 0.011 | 0.011 |
| | K₂O | 0.003 | 0.003 | 0.004 | 0.003 | 0.004 | 0.003 | 0.004 | 0.003 | 0.004 | 0.003 |
| | MgO | <0.02 | 10.10 | 10.01 | 7.61 | 7.51 | 5.09 | 5.04 | 2.57 | 2.50 | 0.05 |
| | CaO | 0.06 | 2.52 | 0.09 | 4.99 | 0.08 | 7.46 | 0.08 | 9.94 | 0.07 | 9.97 |
| | SrO | 12.44 | <0.01 | 2.54 | 0.02 | 5.03 | 0.01 | 7.59 | 0.02 | 9.98 | 2.55 |
| | BaO | 0.17 | <0.004 | 0.03 | <0.004 | 0.07 | <0.004 | 0.09 | <0.004 | 0.12 | 0.03 |
| | SnO₂ | 0.1 | 0.1 | 0.1 | 0.1 | 0.1 | 0.1 | 0.1 | 0.1 | 0.1 | 0.1 |
| | As₂O₃ | <0.01 | <0.01 | <0.01 | <0.01 | <0.01 | <0.01 | <0.01 | <0.01 | <0.01 | <0.01 |
| | Sb₂O₃ | <0.01 | <0.01 | <0.01 | <0.01 | <0.01 | <0.01 | <0.01 | <0.01 | <0.01 | <0.01 |
| | CuO | 0.0 | 0.0 | 0.0 | 0.0 | 0.0 | 0.0 | 0.0 | 0.0 | 0.0 | 0.0 |
| | ZnO | 0.0 | 0.0 | 0.0 | 0.0 | 0.0 | 0.0 | 0.0 | 0.0 | 0.0 | 0.0 |
| | P₂O₃ | 0.0 | 0.0 | 0.0 | 0.0 | 0.0 | 0.0 | 0.0 | 0.0 | 0.0 | 0.0 |
| | TiO₂ | 0.008 | 0.009 | 0.008 | 0.016 | 0.018 | 0.010 | 0.008 | 0.016 | 0.010 | 0.011 |
| | Fe₂O₃ | 0.005 | 0.005 | 0.005 | 0.005 | 0.005 | 0.005 | 0.005 | 0.006 | 0.005 | 0.005 |
| | ZrO₂ | 0.000 | 0.001 | 0.001 | 0.001 | 0.001 | 0.000 | 0.001 | 0.001 | 0.002 | 0.001 |
| | MoO₃ | <0.00003 | 0.0004 | 0.0007 | 0.0012 | 0.0019 | 0.0008 | 0.0020 | <0.00003 | 0.0018 | 0.0022 |
| | Cl | 0.004 | 0.000 | 0.002 | 0.002 | 0.002 | 0.002 | 0.002 | 0.002 | 0.004 | 0.002 |
| | F | <0.07 | <0.07 | <0.07 | <0.07 | <0.07 | <0.07 | <0.07 | <0.07 | <0.07 | <0.07 |

| | | | | | | | | | | |
|---|---|---|---|---|---|---|---|---|---|---|
| MgO + CaO + SrO + | 12.67 | 12.62 | 12.67 | 12.62 | 12.69 | 12.56 | 12.80 | 12.53 | 12.67 | 12.60 |
| BaO | | | | | | | | | | |
| MgO/(MgO + CaO + | 0.00 | 0.80 | 0.79 | 0.60 | 0.59 | 0.41 | 0.39 | 0.21 | 0.20 | 0.00 |
| SrO + BaO) | | | | | | | | | | |
| CaO/(MgO + CaO + | 0.00 | 0.20 | 0.01 | 0.40 | 0.01 | 0.59 | 0.01 | 0.79 | 0.01 | 0.79 |
| SrO + BaO) | | | | | | | | | | |
| SrO/(MgO + CaO + | 0.98 | 0.00 | 0.20 | 0.00 | 0.40 | 0.00 | 0.59 | 0.00 | 0.79 | 0.20 |
| SrO + BaO) | | | | | | | | | | |
| BaO/(MgO + CaO + | 0.01 | 0.00 | 0.00 | 0.00 | 0.01 | 0.00 | 0.01 | 0.00 | 0.01 | 0.00 |
| SrO + BaO) | | | | | | | | | | |
| Density [g/cm³] | 2.61 | 2.39 | 2.42 | 2.39 | 2.47 | 2.40 | 2.51 | 2.41 | 2.56 | 2.46 |
| CTE [×10⁻⁷/° C.] | 40 | 27.6 | 28.5 | 29.4 | 31.2 | 31.4 | 34.6 | 33.5 | 38 | 37.3 |
| Young's modulus | 73.4 | 80.5 | 79.5 | 79.6 | 77.8 | 78.4 | 75.8 | 77.5 | 74.0 | 75.8 |
| [GPa] | | | | | | | | | | |
| Ps [° C.] | 707 | 726 | 723 | 717 | 718 | 714 | 710 | 712 | 707 | 712 |
| Ta [° C.] | 768 | 784 | 781 | 777 | 777 | 773 | 771 | 773 | 770 | 772 |
| Ts [° C.] | 1020 | 1040 | 1032 | 1029 | 1027 | 1022 | 1028 | 1020 | 1029 | 1020 |
| 10^{4.0} dPa · s [° C.] | 1386 | 1365 | 1371 | 1365 | 1379 | 1365 | 1387 | 1369 | 1390 | 1371 |
| 10^{3.0} dPa · s [° C.] | 1572 | 1534 | 1542 | 1536 | 1552 | 1539 | 1564 | 1547 | 1571 | 1550 |
| 10^{2.5} dPa · s [° C.] | 1687 | 1641 | 1651 | 1644 | 1664 | 1651 | 1677 | 1665 | 1682 | 1665 |
| TL [° C.] | 1241 | 1347 | 1315 | 1325 | 1270 | 1292 | 1243 | 1278 | 1226 | 1234 |
| Initial phase | Ano | Cri | Cri | Cri | Cri | Cri | Cri | Cri | Ano | Cri |
| Log₁₀ ηTL | 5.1 | 4.1 | 4.4 | 4.3 | 4.8 | 4.6 | 5.1 | 4.7 | 5.3 | 5.1 |
| HF etching rate | 0.60 | 0.91 | 0.58 | 0.63 | 0.45 | 0.51 | 0.49 | 0.50 | 0.53 | 0.49 |
| [μm/min] | | | | | | | | | | |
| Phase separation | ◯ | ◯ | ◯ | ◯ | ◯ | ◯ | ◯ | ◯ | ◯ | ◯ |
| Surface roughness | 1.539 | 1.386 | Not | Not | Not | Not | 0.962 | Not | Not | 0.882 |
| Sa [nm] | | | measured | measured | measured | measured | | measured | measured | |
| β-OH [/mm] | Not | Not | Not | Not | Not | Not | Not | Not | Not | Not |
| | measured | measured | measured | measured | measured | measured | measured | measured | measured | measured |
| Linear | >90 | >90 | >90 | >90 | >90 | >90 | >90 | >90 | >90 | >90 |
| transmittance at | | | | | | | | | | |
| 450 nm [%] | | | | | | | | | | |

TABLE 3

| | | No. 21 | No. 22 | No. 23 | No. 24 | No. 25 |
|---|---|---|---|---|---|---|
| Glass | SiO₂ | 72.0 | 72.1 | 72.0 | 72.2 | 70.3 |
| composition | Al₂O₃ | 10.0 | 10.0 | 10.0 | 10.1 | 12.6 |
| (mol %) | B₂O₃ | 5.2 | 5.2 | 5.3 | 5.0 | 6.9 |
| | Li₂O | <0.001 | <0.001 | <0.001 | <0.001 | <0.001 |
| | Na₂O | 0.011 | 0.011 | 0.011 | 0.011 | 0.011 |
| | K₂O | 0.003 | 0.003 | 0.003 | 0.002 | 0.002 |
| | MgO | 0.03 | <0.02 | <0.02 | 5.00 | 4.00 |
| | CaO | 7.46 | 4.93 | 2.45 | 2.48 | 1.97 |
| | SrO | 5.03 | 7.49 | 9.94 | 4.97 | 4.04 |
| | BaO | 0.06 | 0.09 | 0.12 | 0.02 | 0.02 |
| | SnO₂ | 0.1 | 0.1 | 0.1 | 0.1 | 0.1 |
| | As₂O₃ | <0.01 | <0.01 | <0.01 | <0.01 | <0.01 |
| | Sb₂O₃ | <0.01 | <0.01 | <0.01 | <0.01 | <0.01 |
| | CuO | 0.0 | 0.0 | 0.0 | 0.0 | 0.0 |
| | ZnO | 0.0 | 0.0 | 0.0 | 0.0 | 0.0 |
| | P₂O₃ | 0.0 | 0.0 | 0.0 | 0.0 | 0.0 |
| | TiO₂ | 0.008 | 0.009 | 0.009 | 0.009 | 0.008 |
| | Fe₂O₃ | 0.005 | 0.005 | 0.005 | 0.005 | 0.004 |
| | ZrO₂ | 0.001 | 0.001 | 0.001 | 0.001 | 0.001 |
| | MoO₃ | <0.00003 | 0.0005 | 0.0015 | 0.0030 | <0.00003 |
| | Cl | 0.002 | 0.004 | 0.004 | 0.002 | 0.002 |
| | F | <0.07 | <0.07 | <0.07 | <0.07 | <0.07 |

| | | | | | |
|---|---|---|---|---|---|
| MgO + CaO + SrO + | 12.58 | 12.51 | 12.51 | 12.47 | 10.03 |
| BaO | | | | | |
| MgO/(MgO + CaO + | 0.00 | 0.00 | 0.00 | 0.40 | 0.4 |
| SrO + BaO) | | | | | |
| CaO/(MgO + CaO + | 0.59 | 0.39 | 0.20 | 0.20 | 0.20 |
| SrO + BaO) | | | | | |
| SrO/(MgO + CaO + | 0.40 | 0.60 | 0.79 | 0.40 | 0.40 |
| SrO + BaO) | | | | | |
| BaO/(MgO + CaO + | 0.00 | 0.01 | 0.01 | 0.00 | 0.00 |
| SrO + BaO) | | | | | |
| Density [g/cm³] | 2.4938 | 2.5305 | 2.5660 | 2.4751 | 2.4454 |
| CTE [×10⁻⁷/° C.] | 38.2 | 38.9 | 40 | 33.5 | 29.9 |
| Young's modulus | 75.1 | 74.4 | 73.4 | 77.0 | 76.3 |
| [GPa] | | | | | |
| Ps [° C.] | 708 | 705 | 704 | 710 | 710 |
| Ta [° C.] | 768 | 766 | 765 | 770 | 770 |
| Ts [° C.] | 1018 | 1019 | 1020 | 1024 | 1017 |
| 10^{4.0} dPa · s [° C.] | 1371 | 1379 | 1384 | 1382 | 1353 |
| 10^{3.0} dPa · s [° C.] | 1552 | 1566 | 1576 | 1559 | 1521 |
| 10^{2.5} dPa · s [° C.] | 1665 | 1688 | 1699 | 1674 | 1626 |
| TL [° C.] | 1213 | 1206 | 1215 | 1267 | >1391 |
| Initial phase | Cri | Cri | Ano | Cri | Not |
| | | | | | measured |
| Log₁₀ ηTL | 5.3 | 5.4 | 5.3 | 4.9 | <3.7 |
| HF etching rate | 0.50 | 0.55 | 0.57 | 0.48 | 0.54 |
| [μm/min] | | | | | |
| Phase separation | ◯ | ◯ | ◯ | ◯ | ◯ |
| Surface | 0.635 | Not | Not | Not | Not |
| roughness Sa | | measured | measured | measured | measured |
| [nm] | | | | | |
| β-OH [/mm] | Not | Not | Not | Not | Not |
| | measured | measured | measured | measured | measured |
| Linear | >90 | >90 | >90 | >90 | >90 |
| transmittance at | | | | | |
| 450 nm [%] | | | | | |

| | | No. 26 | No. 27 | No. 28 | No. 29 | No. 30 |
|---|---|---|---|---|---|---|
| Glass | SiO₂ | 72.6 | 72.3 | 72.3 | 69.8 | 72.3 |
| composition | Al₂O₃ | 10.1 | 15.0 | 12.5 | 15.1 | 12.5 |
| (mol %) | B₂O₃ | 7.1 | 2.6 | 0.0 | 2.5 | 2.6 |
| | Li₂O | <0.001 | <0.001 | <0.001 | <0.001 | <0.001 |
| | Na₂O | 0.021 | 0.011 | 0.011 | 0.011 | 0.011 |
| | K₂O | 0.003 | 0.002 | 0.002 | 0.003 | 0.002 |
| | MgO | 4.00 | 3.95 | 5.99 | 4.99 | 4.98 |
| | CaO | 1.98 | 1.96 | 3.01 | 2.47 | 2.49 |
| | SrO | 3.98 | 4.00 | 5.98 | 4.99 | 4.97 |
| | BaO | 0.02 | 0.02 | 0.03 | 0.02 | 0.02 |
| | SnO₂ | 0.1 | 0.1 | 0.1 | 0.1 | 0.1 |
| | As₂O₃ | <0.01 | <0.01 | <0.01 | <0.01 | <0.01 |
| | Sb₂O₃ | <0.01 | <0.01 | <0.01 | <0.01 | <0.01 |
| | CuO | 0.0 | 0.0 | 0.0 | 0.0 | 0.0 |
| | ZnO | 0.0 | 0.0 | 0.0 | 0.0 | 0.0 |
| | P₂O₃ | 0.0 | 0.0 | 0.0 | 0.0 | 0.0 |
| | TiO₂ | 0.009 | 0.009 | 0.010 | 0.008 | 0.009 |
| | Fe₂O₃ | 0.005 | 0.005 | 0.005 | 0.006 | 0.005 |
| | ZrO₂ | 0.001 | 0.001 | 0.001 | 0.001 | 0.001 |
| | MoO₃ | 0.0010 | <0.00003 | 0.0005 | <0.00003 | 0.0030 |
| | Cl | 0.002 | 0.002 | 0.002 | 0.002 | 0.002 |
| | F | <0.07 | <0.07 | <0.07 | <0.07 | <0.07 |

| | | | | | |
|---|---|---|---|---|---|
| MgO + CaO + SrO + | 9.98 | 9.93 | 15.01 | 12.47 | 12.46 |
| BaO | | | | | |
| MgO/(MgO + CaO + | 0.40 | 0.40 | 0.40 | 0.40 | 0.40 |
| SrO + BaO) | | | | | |
| CaO/(MgO + CaO + | 0.20 | 0.20 | 0.20 | 0.20 | 0.20 |
| SrO + BaO) | | | | | |
| SrO/(MgO + CaO + | 0.40 | 0.40 | 0.40 | 0.40 | 0.40 |
| SrO + BaO) | | | | | |
| BaO/(MgO + CaO + | 0.00 | 0.00 | 0.00 | 0.00 | 0.00 |
| SrO + BaO) | | | | | |
| Density [g/cm³] | 2.4202 | 2.4932 | 2.5700 | 2.5363 | 2.5113 |
| CTE [×10⁻⁷/° C.] | 30.2 | 28.7 | 36.4 | 32.6 | 32.9 |
| Young's modulus | 73.6 | 83.4 | 84.4 | 83.8 | 81.0 |
| [GPa] | | | | | |
| Ps [° C.] | 702 | 756 | 771 | 752 | 747 |
| Ta [° C.] | 764 | 818 | 829 | 811 | 808 |
| Ts [° C.] | 1026 | 1061 | 1064 | 1043 | 1053 |
| 10^{4.0} dPa · s [° C.] | 1390 | 1391 | 1392 | 1358 | 1391 |
| 10^{3.0} dPa · s [° C.] | 1567 | 1551 | 1557 | 1516 | 1559 |
| 10^{2.5} dPa · s [° C.] | 1681 | 1654 | 1662 | 1614 | 1666 |
| TL [° C.] | 1195 | >1391 | 1263 | >1404 | 1252 |
| Initial phase | Cri | Not | Ano | Not | Mul |
| | | measured | | measured | |
| Log₁₀ ηTL | 5.6 | <4.0 | 5.1 | <3.7 | 5.2 |
| HF etching rate | 0.51 | 0.42 | 0.50 | 0.58 | 0.47 |
| [μm/min] | | | | | |
| Phase separation | ◯ | ◯ | ◯ | ◯ | ◯ |
| Surface | Not | Not | Not | Not | Not |
| roughness Sa | measured | measured | measured | measured | measured |
| [nm] | | | | | |
| β-OH [/mm] | Not | Not | Not | Not | Not |
| | measured | measured | measured | measured | measured |
| Linear | >90 | >90 | >90 | >90 | 91.5 |
| transmittance at | | | | | |
| 450 nm [%] | | | | | |

TABLE 4

| | | No. 31 | No. 32 | No. 33 | No. 34 | No. 35 |
|---|---|---|---|---|---|---|
| Glass | SiO₂ | 69.6 | 69.6 | 72.3 | 69.55 | 69.9 |
| composition | Al₂O₃ | 20.1 | 17.6 | 14.9 | 17.6 | 10.1 |
| (mol %) | B₂O₃ | 0.0 | 0.0 | 0.0 | 2.7 | 4.9 |
| | Li₂O | <0.001 | <0.001 | <0.001 | <0.001 | <0.001 |
| | Na₂O | 0.011 | 0.011 | 0.011 | 0.011 | 0.011 |
| | K₂O | 0.001 | 0.002 | 0.002 | 0.002 | 0.002 |
| | MgO | 3.99 | 5.00 | 4.97 | 3.98 | 5.99 |
| | CaO | 1.99 | 2.52 | 2.49 | 1.99 | 2.97 |
| | SrO | 4.08 | 5.06 | 5.12 | 3.99 | 5.94 |
| | BaO | 0.02 | 0.02 | 0.02 | 0.02 | 0.03 |
| | SnO₂ | 0.1 | 0.1 | 0.1 | 0.1 | 0.1 |
| | As₂O₃ | <0.01 | <0.01 | <0.01 | <0.01 | <0.01 |
| | Sb₂O₃ | <0.01 | <0.01 | <0.01 | <0.01 | <0.01 |
| | CuO | 0.0 | 0.0 | 0.0 | 0.0 | 0.0 |
| | ZnO | 0.0 | 0.0 | 0.0 | 0.0 | 0.0 |
| | P₂O₃ | 0.0 | 0.0 | 0.0 | 0.0 | 0.0 |
| | TiO₂ | 0.009 | 0.009 | 0.008 | 0.008 | 0.007 |
| | Fe₂O₃ | 0.006 | 0.006 | 0.006 | 0.005 | 0.005 |
| | ZrO₂ | 0.001 | 0.001 | 0.001 | 0.001 | 0.001 |
| | MoO₃ | <0.00003 | <0.00003 | <0.00003 | <0.00003 | 0.0011 |
| | Cl | 0.002 | 0.002 | 0.004 | 0.002 | 0.002 |
| | F | <0.07 | <0.07 | <0.07 | <0.07 | <0.07 |

| | | | | | |
|---|---|---|---|---|---|
| MgO + CaO + SrO + | 10.08 | 12.60 | 12.60 | 9.98 | 14.93 |
| BaO | | | | | |
| MgO/(MgO + CaO + | 0.40 | 0.40 | 0.39 | 0.40 | 0.40 |
| SrO + BaO) | | | | | |
| CaO/(MgO + CaO + | 0.20 | 0.20 | 0.20 | 0.20 | 0.20 |
| SrO + BaO) | | | | | |
| SrO/(MgO + CaO + | 0.40 | 0.40 | 0.41 | 0.40 | 0.40 |
| SrO + BaO) | | | | | |
| BaO/(MgO + CaO + | 0.00 | 0.00 | 0.00 | 0.00 | 0.00 |
| SrO + BaO) | | | | | |
| Density [g/cm³] | 2.56 | 2.58 | 2.55 | 2.52 | 2.52 |
| CTE [×10⁻⁷/° C.] | 29.3 | 32.5 | 32.6 | 29.3 | 37 |
| Young's modulus | 90.5 | 88.3 | 86.0 | 85.9 | 78.1 |
| [GPa] | | | | | |
| Ps [° C.] | Not | 783 | 784 | Not | 699 |
| | measured | | | measured | |
| Ta [° C.] | Not | 840 | 843 | Not | 756 |
| | measured | | | measured | |
| Ts [° C.] | Not | 1064 | 1078 | Not | 945 |
| | measured | | | measured | |
| 10^{4.0} dPa · s [° C.] | Not | 1366 | 1397 | 1384 | 1331 |
| | measured | | | | |
| 10^{3.0} dPa · s [° C.] | Not | 1514 | 1557 | 1509 | 1500 |
| | measured | | | | |
| 10^{2.5} dPa · s [° C.] | Not | 1607 | 1659 | 1600 | 1608 |
| | measured | | | | |
| TL [° C.] | >1387 | >1389 | >1404 | >1412 | 1235 |
| Initial phase | Not | Not | Not | Not | Cri |
| | measured | measured | measured | measured | |
| Log₁₀ ηTL | Not | <3.8 | <4.0 | Not | 4.6 |
| | measured | | | measured | |
| HF etching rate | 0.54 | 0.66 | 0.50 | 0.47 | 0.58 |
| [μm/min] | | | | | |
| Phase separation | ◯ | ◯ | ◯ | ◯ | ◯ |
| Surface roughness | Not | Not | Not | Not | Not |
| Sa [nm] | measured | measured | measured | measured | measured |
| β-OH [/mm] | Not | Not | Not | Not | Not |
| | measured | measured | measured | measured | measured |
| Linear | >90 | >90 | >90 | >90 | >90 |
| transmittance at | | | | | |
| 450 nm [%] | | | | | |

| | | No. 36 | No. 37 | No. 38 | No. 39 | No. 40 |
|---|---|---|---|---|---|---|
| Glass | SiO₂ | 69.8 | 70.1 | 69.9 | 72.4 | 69.9 |
| composition | Al₂O₃ | 12.5 | 10.0 | 15.0 | 7.5 | 12.5 |
| (mol %) | B₂O₃ | 2.6 | 7.3 | 0.0 | 5.0 | 5.0 |
| | Li₂O | <0.001 | <0.001 | <0.001 | <0.001 | <0.001 |
| | Na₂O | 0.011 | 0.011 | 0.011 | 0.010 | 0.011 |
| | K₂O | 0.003 | 0.002 | 0.001 | 0.002 | 0.002 |
| | MgO | 5.98 | 5.00 | 5.93 | 6.00 | 4.99 |
| | CaO | 3.00 | 2.46 | 2.95 | 2.99 | 2.47 |
| | SrO | 5.94 | 4.98 | 6.04 | 5.89 | 4.96 |
| | BaO | 0.03 | 0.02 | 0.03 | 0.03 | 0.02 |
| | SnO₂ | 0.1 | 0.1 | 0.1 | 0.1 | 0.1 |
| | As₂O₃ | <0.01 | <0.01 | <0.01 | <0.01 | <0.01 |
| | Sb₂O₃ | <0.01 | <0.01 | <0.01 | <0.01 | <0.01 |
| | CuO | 0.0 | 0.0 | 0.0 | 0.0 | 0.0 |
| | ZnO | 0.0 | 0.0 | 0.0 | 0.0 | 0.0 |
| | P₂O₃ | 0.0 | 0.0 | 0.0 | 0.0 | 0.0 |
| | TiO₂ | 0.007 | 0.007 | 0.007 | 0.007 | 0.007 |
| | Fe₂O₃ | 0.005 | 0.005 | 0.005 | 0.004 | 0.005 |
| | ZrO₂ | 0.001 | 0.001 | 0.001 | 0.001 | 0.001 |
| | MoO₃ | 0.0013 | 0.0001 | <0.00003 | 0.0001 | 0.0001 |
| | Cl | 0.002 | 0.002 | 0.004 | 0.002 | 0.004 |
| | F | <0.07 | <0.07 | <0.07 | <0.07 | <0.07 |

| | | | | | |
|---|---|---|---|---|---|
| MgO + CaO + SrO + | 14.95 | 12.46 | 14.95 | 14.91 | 12.44 |
| BaO | | | | | |
| MgO/(MgO + CaO + | 0.40 | 0.40 | 0.40 | 0.40 | 0.40 |
| SrO + BaO) | | | | | |
| CaO/(MgO + CaO + | 0.20 | 0.20 | 0.20 | 0.20 | 0.20 |
| SrO + BaO) | | | | | |
| SrO/(MgO + CaO + | 0.40 | 0.40 | 0.40 | 0.40 | 0.40 |
| SrO + BaO) | | | | | |
| BaO/(MgO + CaO + | 0.00 | 0.00 | 0.00 | 0.00 | 0.00 |
| SrO + BaO) | | | | | |
| Density [g/cm³] | 2.56 | 2.46 | 2.59 | 2.50 | 2.50 |
| CTE [×10⁻⁷/° C.] | 36.5 | 34.2 | 36 | 36.8 | 33.2 |
| Young's modulus | 82.1 | 74.8 | 87.0 | 76.5 | 79.2 |
| [GPa] | | | | | |
| Ps [° C.] | 735 | 688 | 776 | 686 | 720 |
| Ta [° C.] | 793 | 747 | 833 | 743 | 779 |
| Ts [° C.] | 1028 | 995 | 1059 | 990 | 1020 |
| 10^{4.0} dPa · s [° C.] | 1347 | 1345 | 1366 | 1345 | 1353 |
| 10^{3.0} dPa · s [° C.] | 1509 | 1520 | 1522 | 1530 | 1518 |
| 10^{2.5} dPa · s [° C.] | 1610 | 1630 | 1619 | 1651 | 1620 |
| TL [° C.] | 1211 | 1183 | >1396 | 1309 | 1257 |
| Initial phase | Ano | Cri | Mul | Cri | Mul |
| Log₁₀ ηTL | 5.2 | 5.3 | <3.8 | 4.3 | 4.8 |
| HF etching rate | 0.63 | 0.62 | 0.71 | 0.83 | 0.55 |
| [μm/min] | | | | | |
| Phase separation | ◯ | ◯ | ◯ | ◯ | ◯ |
| Surface roughness | Not | Not | Not | Not | Not |
| Sa [nm] | measured | measured | measured | measured | measured |
| β-OH [/mm] | Not | Not | Not | Not | Not |
| | measured | measured | measured | measured | measured |
| Linear | >90 | >90 | >90 | >90 | >90 |
| transmittance at | | | | | |
| 450 nm [%] | | | | | |

TABLE 5

| | | No. 41 | No. 42 | No. 43 | No. 44 | No. 45 | No. 46 |
|---|---|---|---|---|---|---|---|
| Glass | SiO₂ | 69.8 | 72.2 | 72.3 | 69.9 | 70.2 | 70.0 |
| composition | Al₂O₃ | 15.1 | 12.6 | 10.0 | 5.1 | 5.0 | 5.0 |
| (mol %) | B₂O₃ | 4.9 | 5.0 | 2.6 | 9.6 | 9.5 | 9.8 |
| | Li₂O | <0.001 | <0.001 | <0.001 | <0.001 | <0.001 | <0.001 |
| | Na₂O | 0.011 | 0.011 | 0.011 | <0.011 | <0.011 | <0.011 |
| | K₂O | 0.001 | 0.002 | 0.002 | 0.002 | 0.002 | 0.002 |
| | MgO | 3.99 | 4.02 | 5.97 | 6.06 | 3.05 | 3.01 |
| | CaO | 1.98 | 2.02 | 2.99 | 3.06 | 6.01 | 3.01 |
| | SrO | 4.01 | 3.98 | 5.91 | 3.06 | 3.02 | 5.94 |
| | BaO | 0.02 | 0.02 | 0.03 | 3.05 | 3.01 | 3.03 |
| | SnO₂ | 0.1 | 0.1 | 0.1 | 0.1 | 0.1 | 0.1 |
| | As₂O₃ | <0.01 | <0.01 | <0.01 | <0.01 | <0.01 | <0.01 |
| | Sb₂O₃ | <0.01 | <0.01 | <0.01 | <0.01 | <0.01 | <0.01 |
| | CuO | 0.0 | 0.0 | 0.0 | 0.0 | 0.0 | 0.0 |
| | ZnO | 0.0 | 0.0 | 0.0 | 0.0 | 0.0 | 0.0 |
| | P₂O₃ | 0.0 | 0.0 | 0.0 | 0.0 | 0.0 | 0.0 |
| | TiO₂ | 0.007 | 0.007 | 0.00 | 0.007 | 0.007 | 0.008 |
| | Fe₂O₃ | 0.005 | 0.005 | 0.005 | 0.006 | 0.006 | 0.006 |
| | ZrO₂ | 0.001 | 0.001 | 0.001 | <0.001 | 0.001 | 0.001 |
| | MoO₃ | 0.0002 | 0.0025 | 0.0028 | <0.00003 | <0.00003 | <0.00003 |
| | Cl | 0.002 | 0.002 | 0.004 | 0.004 | 0.002 | 0.004 |
| | F | <0.07 | <0.07 | <0.07 | <0.07 | <0.07 | <0.07 |

| | | | | | | |
|---|---|---|---|---|---|---|
| MgO + CaO + SrO + BaO | 10.00 | 10.04 | 14.90 | 15.23 | 15.09 | 14.99 |
| MgO/(MgO + CaO + SrO + BaO) | 0.40 | 0.40 | 0.40 | 0.40 | 0.20 | 0.20 |
| CaO/(MgO + CaO + SrO + BaO) | 0.20 | 0.20 | 0.20 | 0.20 | 0.40 | 0.20 |
| SrO/(MgO + CaO + SrO + BaO) | 0.40 | 0.40 | 0.40 | 0.20 | 0.20 | 0.40 |
| BaO/(MgO + CaO + SrO + BaO) | 0.00 | 0.00 | 0.00 | 0.20 | 0.20 | 0.20 |
| Density [g/cm³] | 2.48 | 2.46 | 2.53 | 2.52 | 2.54 | 2.59 |
| CTE [×10⁻⁷/° C.] | 29.4 | 29.3 | 36.8 | 38.2 | 40.6 | 41.6 |
| Young's modulus [GPa] | 81.4 | 78.9 | 80.3 | Not measured | Not measured | Not measured |
| Ps [° C.] | 731 | 727 | 722 | 654 | 652 | 650 |
| Ta [° C.] | 791 | 789 | 782 | 705 | 700 | 695 |
| Ts [° C.] | 1032 | 1040 | 1027 | 1036 | 1044 | 1010 |
| 10^{4.0} dPa · s [° C.] | 1356 | 1387 | 1369 | 1283 | 1256 | 1246 |
| 10^{3.0} dPa · s [° C.] | 1514 | 1557 | 1542 | 1468 | 1436 | 1428 |
| 10^{2.5} dPa · s [° C.] | 1613 | 1668 | 1653 | 1588 | 1553 | 1546 |
| TL [° C.] | >1392 | >1396 | 1313 | ≥1246 | ≥1254 | ≥1251 |
| Initial phase | Not measured | Mul | Cri | Cri | Cri | Cri |
| Log₁₀ ηTL | <3.8 | <3.9 | 4.4 | ≤4.4 | ≤4.0 | ≤4.0 |
| HF etching rate [μm/min] | 0.51 | 0.44 | 0.46 | 2.37 | 2.70 | 2.32 |
| Phase separation | ◯ | ◯ | ◯ | X | X | X |
| Surface roughness Sa [nm] | Not measured | Not measured | Not measured | 6.292 | 5.385 | 4.476 |
| β-OH [/mm] | Not measured | Not measured | Not measured | Not measured | Not measured | Not measured |
| Linear transmittance at 450 | >90 | >90 | >90 | <80 | 79.6 | <80 |
| nm [%] | | | | | | |

First, glass raw materials were mixed to give a glass composition presented in Tables 1 to 5, and the glass batch was charged into a platinum crucible and melted at a temperature of from 1600° C. to 1650° C. for 24 hours. At the time of melting, the glass batch was homogenized by stirring with a platinum stirrer. Next, the molten glass was poured onto a carbon sheet, formed into a sheet shape, and then gradually cooled at a temperature near the annealing point for 30 minutes. Each of the obtained samples was evaluated for the density, the average thermal expansion coefficient CTE in a temperature range of from 30° C. to 380° C., the Young's modulus, the strain point Ps, the annealing point Ta, the softening point Ts, the temperature at a viscosity in high temperature of 10^{4.0} dPa·s, the temperature at a viscosity in high temperature of 10^{3.0} dPa·s, the temperature at a viscosity in high temperature of 10^{2.5} dPa·s, the liquidus temperature TL, the initial phase, the viscosity log₁₀ ηTL at the liquidus temperature TL, the HF etching rate. the phase separation, the surface roughness Sa, and the β-OH value.

The density is a value measured using the well-known Archimedes method.

The average thermal expansion coefficient CTE in a temperature range of from 30° C. to 380° C. is a value measured with a dilatometer.

The Young's modulus refers to a value measured by using a well-known resonance method.

The strain point Ps, the annealing point Ta, and the softening point Ts are values measured based on methods in ASTM C336 and C338.

The temperatures at a viscosity in high temperature of 10^{4.0} dPa·s, 10^{3.0} dPa·s, and 10^{2.5} dPa·s are values measured by using a platinum sphere pull up method.

The liquidus temperature TL is a temperature at which crystals precipitate after a glass powder that has passed through a standard 30-mesh sieve (500 μm) and remained on a 50-mesh sieve (300 μm) is charged into a platinum boat and then kept in a temperature gradient furnace for 24 hours. The crystals were then evaluated as the initial phase. Note that, in the tables, “Cri” refers to cristobalite, “Mul” refers to mullite, and “Ano” refers to anorthite.

The liquidus viscosity log₁₀ ηTL is a value obtained by measuring the viscosity of the glass at the liquidus temperature TL by using a platinum sphere pull up method.

The HF etching rate refers to a value measured by using the following method. First, both surfaces of the sample were optically polished, then annealed and partially masked. 300 mL of a 2.5 mol/L HF solution was stirred at about 600 rpm using a water bath stirrer set at 30° C. The glass substrate was immersed in the HF solution for 20 minutes. Thereafter, the mask was removed, the sample was washed, and the step between the masked portion and the eroded portion was measured using a Surfcorder (ET4000A, manufactured by Kosaka Laboratory Ltd.). The etching rate was calculated by dividing the value by an immersion time.

The phase separation was evaluated by rating “o” when the linear transmittance at a wavelength of 450 nm at a thickness of 1 mm was 89.5% or more, and rating “x” when it was less than 89.5%.

The surface roughness Sa of the glass substrate was measured using NewView 7300 (manufactured by Zygo Corporation) on the etched surface of the sample for which the HF etching rate was measured. The measurement conditions were a 50× objective lens, a 1× zoom lens, 8 times of integrations, and a camera pixel count of 640×480, and the surface roughness Sa was measured over an observation field of 140 μm×105 μm. The image processing conditions used were plane for shape removal, Band Pass for filter, Gauss Spline for filter type, a L filter value of 26.00 μm, and a S filter value of 0.66 μm.

The β-OH value refers to a value determined based on the transmittance of the glass measured by using FT-IR according to the above method.

As seen from Tables 1 to 5, the glasses in samples Nos. 1 to 43 have appropriate contents of Al₂O₃ and BaO, and therefore have a low HF etching rate of 1.31 μm/min or less, a transmittance of more than 90%, and do not undergo phase separation. On the other hand, the samples Nos. 44 to 46, which are Comparative Examples, have a transmittance of less than 80% and undergo phase separation due to a small content of Al₂O₃, and have a high HF etching rate of 2.32 μm/min or more due to a large content of BaO.

### Example 2

Further, for the samples Nos. 1 to 43 and the sample No. 44, fine holes were prepared by using the following method, and the taper angles of the through holes and the non-through holes were checked.

First, each glass substrate was prepared, which had a rectangular surface of 35 mm×20 mm and a thickness of 500 μm. The glass substrate was irradiated with a femtosecond pulse laser formed into a Bessel beam shape at a pitch interval of 160 μm, forming approximately 5000 modified portions in a central region of 12.8 mm×9.6 mm in the glass substrate.

Next, the glass substrate was subjected to etching for a predetermined period of time. Specifically, the glass substrate was charged into a PP test tube containing an etching solution, and ultrasonic waves were applied to the etching solution to perform etching, thereby forming holes in the glass substrate. At this time, the glass substrate was fixed at a distance of 40 mm from the bottom of the test tube using a Teflon (registered trademark) jig. The shapes of the prepared through holes and non-through holes were as shown in FIG. 2 or FIG. 3, and the shape parameters were measured using a transmission optical microscope (Eclipse LV100ND, manufactured by Nikon Corporation) by using the method described above.

Note that, the etching solution used was a mixed acid of 2.5 mol/L HF and 1.0 mol/L HCl solution, and the temperature of the etching solution was set to 30° C. In order to prevent the temperature from increasing during application of ultrasonic waves, a chiller was used to circulate water inside an ultrasonic device, and the water temperature was maintained at 30° C. The ultrasonic vibration was applied using an ultrasonic cleaner (VS-100III, manufactured by AS ONE Corporation). Accordingly, ultrasonic waves of 28 kHz were applied to the etching solution.

Tables 6 to 12 show the thickness of the prepared glass substrate, the shape of the glass substrate after etching, and the shape of the holes prepared by etching. The “HF etching rates” shown in Tables 6 to 12 are the same as the values shown in Tables 1 to 5 measured for each glass sample in Example 1. Note that, as described above, the etching conditions in forming the hole in Example 2 are different from the etching conditions in measuring the HF etching rate in Example 1. Therefore, it is thought that the etching rate in forming the holes in Example 2 is a value different from the “HF etching rate” in the table.

TABLE 6

| Glass sample | No. 1 | No. 1 | No. 1 | No. 2 | No. 2 | No. 2 | No. 3 | No. 3 | No. 3 |
|---|---|---|---|---|---|---|---|---|---|
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 510 | 510 | 510 | 515 | 515 | 515 | 505 | 505 | 505 |
| Thickness tA after etching [μm] | 497 | 480 | 468 | 502 | 488 | 475 | 491 | 476 | 464 |
| Thickness reduction amount Δt [μm] | 13 | 30 | 42 | 13 | 27 | 40 | 14 | 29 | 41 |
| Opening diameter Φ1 [μm] | 14 | 28 | 38 | 14 | 26 | 39 | 13 | 26 | 37 |
| Opening diameter Φ2 [μm] | 14 | 28 | 39 | 14 | 26 | 39 | 11 | 25 | 35 |
| Inner diameter Φ3 [μm] | — | — | — | — | — | — | — | — | — |
| Hole depth t1 [μm] | 128 | 185 | 221 | 121 | 181 | 226 | 118 | 177 | 235 |
| Hole depth t2 [μm] | 97 | 168 | 225 | 99 | 159 | 229 | 64 | 166 | 200 |
| Taper angle θ1 [°] | 3.2 | 4.4 | 4.9 | 3.2 | 4.2 | 4.9 | 3.2 | 4.1 | 4.5 |
| Taper angle θ2 [°] | 4.1 | 4.8 | 5.0 | 4.0 | 4.7 | 4.9 | 5.1 | 4.3 | 5.0 |
| Average taper angle θ [°] ((θ1 + θ2)/2) | 3.6 | 4.6 | 5.0 | 3.6 | 4.4 | 4.9 | 4.1 | 4.2 | 4.7 |
| HF etching rate [μm/min] | 0.52 | 0.52 | 0.52 | 0.51 | 0.51 | 0.51 | 0.50 | 0.50 | 0.50 |
| Glass sample | No. 4 | No. 4 | No. 4 | No. 5 | No. 5 | No. 5 | No. 6 | No. 6 | No. 6 |
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 510 | 510 | 510 | 500 | 500 | 500 | 500 | 500 | 500 |
| Thickness tA after etching [μm] | 498 | 488 | 472 | 485 | 474 | 458 | 488 | 476 | 461 |
| Thickness reduction amount Δt [μm] | 12 | 22 | 38 | 15 | 26 | 42 | 12 | 24 | 39 |
| Opening diameter Φ1 [μm] | 15 | 26 | 37 | 14 | 25 | 39 | 15 | 26 | 36 |
| Opening diameter Φ2 [μm] | 13 | 25 | 37 | 13 | 24 | 35 | 13 | 25 | 36 |
| Inner diameter Φ3 [μm] | — | — | — | — | — | — | — | — | — |
| Hole depth t1 [μm] | 113 | 165 | 224 | 112 | 167 | 223 | 114 | 165 | 212 |
| Hole depth t2 [μm] | 60 | 140 | 189 | 86 | 149 | 198 | 90 | 145 | 202 |
| Taper angle θ1 [°] | 3.7 | 4.5 | 4.7 | 3.6 | 4.3 | 5.0 | 3.7 | 4.5 | 4.9 |
| Taper angle θ2 [°] | 6.1 | 5.1 | 5.5 | 4.3 | 4.7 | 5.1 | 4.2 | 4.9 | 5.1 |
| Average taper angle θ [°] ((θ1 + θ2)/2) | 4.9 | 4.8 | 5.1 | 3.9 | 4.5 | 5.0 | 4.0 | 4.7 | 5.0 |
| HF etching rate [μm/min] | 0.51 | 0.51 | 0.51 | 0.51 | 0.51 | 0.51 | 0.53 | 0.53 | 0.53 |

TABLE 7

| Glass sample | No. 7 | No. 7 | No. 7 | No. 8 | No. 8 | No. 8 | No. 9 | No. 9 | No. 9 |
|---|---|---|---|---|---|---|---|---|---|
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 505 | 505 | 505 | 500 | 500 | 500 | 500 | 500 | 500 |
| Thickness tA after etching [μm] | 486 | 469 | 449 | 485 | 470 | 451 | 472 | 438 | 406 |
| Thickness reduction amount Δt [μm] | 19 | 36 | 56 | 15 | 30 | 49 | 28 | 62 | 94 |
| Opening diameter Φ1 [μm] | 15 | 31 | 45 | 17 | 32 | 44 | 28 | 55 | 81 |
| Opening diameter Φ2 [μm] | 17 | 30 | 44 | 16 | 30 | 42 | 27 | 53 | 79 |
| Inner diameter Φ3 [μm] | — | — | — | — | — | — | — | — | — |
| Hole depth t1 [μm] | 112 | 160 | 211 | 123 | 174 | 227 | 106 | 152 | 206 |
| Hole depth t2 [μm] | 117 | 173 | 216 | 96 | 157 | 196 | 90 | 128 | 188 |
| Taper angle θ1 [°] | 3.8 | 5.4 | 6.1 | 4.0 | 5.2 | 5.5 | 7.5 | 10.2 | 11.1 |
| Taper angle θ2 [°] | 4.1 | 5.0 | 5.8 | 4.9 | 5.5 | 6.1 | 8.6 | 11.7 | 11.9 |
| Average taper angle θ [°] ((θ1 + θ2)/2) | 4.0 | 5.2 | 5.9 | 4.4 | 5.4 | 5.8 | 8.1 | 11.0 | 11.5 |
| HF etching rate [μm/min] | 0.59 | 0.59 | 0.59 | 0.56 | 0.56 | 0.56 | 1.31 | 1.31 | 1.31 |
| Glass sample | No. 10 | No. 10 | No. 10 | No. 11 | No. 11 | No. 11 | No. 12 | No. 12 | No. 12 |
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 495 | 495 | 495 | 480 | 480 | 480 | 515 | 515 | 515 |
| Thickness tA after etching [μm] | 482 | 462 | 454 | 462 | 447 | 434 | 492 | 463 | 450 |
| Thickness reduction amount Δt [μm] | 13 | 33 | 41 | 18 | 33 | 46 | 23 | 52 | 65 |
| Opening diameter Φ1 [μm] | 15 | 28 | 40 | 18 | 32 | 41 | 24 | 46 | 53 |
| Opening diameter Φ2 [μm] | 14 | 27 | 39 | 17 | 31 | 40 | 24 | 46 | 54 |
| Inner diameter Φ3 [μm] | — | — | — | — | — | — | — | — | — |
| Hole depth t1 [μm] | 78 | 120 | 156 | 100 | 152 | 192 | 120 | 177 | 217 |
| Hole depth t2 [μm] | 68 | 117 | 145 | 77 | 146 | 189 | 103 | 149 | 196 |
| Taper angle θ1 [°] | 5.5 | 6.6 | 7.4 | 5.1 | 6.1 | 6.1 | 5.8 | 7.4 | 7.0 |
| Taper angle θ2 [°] | 5.9 | 6.6 | 7.8 | 6.4 | 6.1 | 6.0 | 6.6 | 8.7 | 7.8 |
| Average taper angle θ [°] ((θ1 + θ2)/2) | 5.7 | 6.6 | 7.6 | 5.8 | 6.1 | 6.0 | 6.2 | 8.1 | 7.4 |
| HF etching rate [μm/min] | 0.52 | 0.52 | 0.52 | 0.60 | 0.60 | 0.60 | 0.91 | 0.91 | 0.91 |

TABLE 8

| Glass sample | No. 13 | No. 13 | No. 13 | No. 14 | No. 14 | No. 14 | No. 15 | No. 15 | No. 15 |
|---|---|---|---|---|---|---|---|---|---|
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 510 | 510 | 510 | 510 | 510 | 510 | 500 | 500 | 500 |
| Thickness tA after etching [μm] | 493 | 476 | 455 | 491 | 473 | 459 | 486 | 473 | 462 |
| Thickness reduction amount Δt [μm] | 17 | 34 | 55 | 19 | 37 | 51 | 14 | 27 | 38 |
| Opening diameter Φ1 [μm] | 14 | 33 | 47 | 18 | 31 | 46 | 14 | 24 | 37 |
| Opening diameter Φ2 [μm] | 16 | 31 | 46 | 16 | 31 | 44 | 13 | 24 | 35 |
| Inner diameter Φ3 [μm] | — | — | — | — | — | — | — | — | — |
| Hole depth t1 [μm] | 110 | 182 | 229 | 116 | 173 | 219 | 120 | 175 | 236 |
| Hole depth t2 [μm] | 101 | 152 | 196 | 92 | 147 | 189 | 88 | 147 | 189 |
| Taper angle θ1 [°] | 3.6 | 5.2 | 5.9 | 4.4 | 5.2 | 6.0 | 3.3 | 4.0 | 4.5 |
| Taper angle θ2 [°] | 4.5 | 5.9 | 6.6 | 5.0 | 6.0 | 6.7 | 4.1 | 4.7 | 5.2 |
| Average taper angle θ [°] ((θ1 + θ2)/2) | 4.0 | 5.5 | 6.3 | 4.7 | 5.6 | 6.3 | 3.7 | 4.4 | 4.8 |
| HF etching rate [μm/min] | 0.58 | 0.58 | 0.58 | 0.63 | 0.63 | 0.63 | 0.45 | 0.45 | 0.45 |
| Glass sample | No. 16 | No. 16 | No. 16 | No. 17 | No. 17 | No. 17 | No. 18 | No. 18 | No. 18 |
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 510 | 510 | 510 | 500 | 500 | 500 | 505 | 505 | 505 |
| Thickness tA after etching [μm] | 494 | 482 | 462 | 486 | 469 | 457 | 486 | 469 | 453 |
| Thickness reduction amount Δt [μm] | 16 | 28 | 48 | 14 | 31 | 43 | 19 | 36 | 52 |
| Opening diameter Φ1 [μm] | 15 | 27 | 39 | 15 | 27 | 37 | 14 | 26 | 38 |
| Opening diameter Φ2 [μm] | 14 | 26 | 37 | 13 | 25 | 36 | 13 | 24 | 37 |
| Inner diameter Φ3 [μm] | — | — | — | — | — | — | — | — | — |
| Hole depth t1 [μm] | 106 | 157 | 209 | 113 | 177 | 220 | 85 | 141 | 177 |
| Hole depth t2 [μm] | 83 | 124 | 160 | 78 | 137 | 195 | 77 | 110 | 146 |
| Taper angle θ1 [°] | 4.0 | 4.9 | 5.3 | 3.8 | 4.4 | 4.8 | 4.5 | 5.3 | 6.1 |
| Taper angle θ2 [°] | 4.8 | 5.9 | 6.5 | 4.8 | 5.2 | 5.2 | 4.9 | 6.4 | 7.1 |
| Average taper angle θ [°] ((θ1 + θ2)/2) | 4.4 | 5.4 | 5.9 | 4.3 | 4.8 | 5.0 | 4.7 | 5.8 | 6.6 |
| HF etching rate [μm/min] | 0.51 | 0.51 | 0.51 | 0.49 | 0.49 | 0.49 | 0.50 | 0.50 | 0.50 |

TABLE 9

| Glass sample | No. 19 | No. 19 | No. 19 | No. 20 | No. 20 | No. 20 | No. 21 | No. 21 | No. 21 |
|---|---|---|---|---|---|---|---|---|---|
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 515 | 515 | 515 | 500 | 500 | 500 | 495 | 495 | 495 |
| Thickness tA after etching [μm] | 499 | 483 | 467 | 485 | 469 | 460 | 483 | 470 | 457 |
| Thickness reduction amount Δt [μm] | 16 | 32 | 48 | 15 | 31 | 40 | 12 | 25 | 38 |
| Opening diameter Φ1 [μm] | 16 | 29 | 41 | 16 | 29 | 41 | 16 | 28 | 41 |
| Opening diameter Φ2 [μm] | 15 | 27 | 41 | 15 | 27 | 39 | 14 | 27 | 38 |
| Inner diameter Φ3 [μm] | — | — | — | — | — | — | — | — | — |
| Hole depth t1 [μm] | 105 | 166 | 206 | 105 | 170 | 216 | 100 | 155 | 211 |
| Hole depth t2 [μm] | 79 | 133 | 176 | 82 | 136 | 185 | 74 | 132 | 180 |
| Taper angle θ1 [°] | 4.4 | 4.9 | 5.6 | 4.3 | 4.9 | 5.4 | 4.6 | 5.2 | 5.6 |
| Taper angle θ2 [°] | 5.3 | 5.7 | 6.6 | 5.2 | 5.7 | 6.0 | 5.6 | 5.8 | 6.1 |
| Average taper angle θ [°] ((θ1 + θ2)/2) | 4.8 | 5.3 | 6.1 | 4.7 | 5.3 | 5.7 | 5.1 | 5.5 | 5.8 |
| HF etching rate [μm/min] | 0.53 | 0.53 | 0.53 | 0.49 | 0.49 | 0.49 | 0.50 | 0.50 | 0.50 |
| Glass sample | No. 22 | No. 22 | No. 22 | No. 23 | No. 23 | No. 23 | No. 24 | No. 24 | No. 24 |
| Etching time [min] | 10 | 20 | 30 | 10 | 20 | 30 | 10 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 510 | 510 | 510 | 495 | 495 | 495 | 510 | 510 | 510 |
| Thickness tA after etching [μm] | 495 | 480 | 466 | 478 | 460 | 444 | 498 | 486 | 473 |
| Thickness reduction amount Δt [μm] | 15 | 30 | 44 | 17 | 35 | 51 | 12 | 24 | 37 |
| Opening diameter Φ1 [μm] | 16 | 30 | 41 | 16 | 30 | 43 | 14 | 26 | 36 |
| Opening diameter Φ2 [μm] | 15 | 27 | 38 | 15 | 28 | 41 | 13 | 24 | 35 |
| Inner diameter Φ3 [μm] | — | — | — | — | — | — | — | — | — |
| Hole depth t1 [μm] | 95 | 167 | 210 | 94 | 162 | 205 | 117 | 186 | 232 |
| Hole depth t2 [μm] | 77 | 131 | 172 | 82 | 133 | 197 | 95 | 158 | 200 |
| Taper angle θ1 [°] | 4.9 | 5.1 | 5.6 | 5.0 | 5.4 | 5.9 | 3.5 | 4.0 | 4.5 |
| Taper angle θ2 [°] | 5.5 | 6.0 | 6.4 | 5.2 | 6.0 | 5.9 | 3.9 | 4.4 | 4.9 |
| Average taper angle θ [°] ((θ1 + θ2)/2) | 5.2 | 5.5 | 6.0 | 5.1 | 5.7 | 5.9 | 3.7 | 4.2 | 4.7 |
| HF etching rate [μm/min] | 0.55 | 0.55 | 0.55 | 0.57 | 0.57 | 0.57 | 0.48 | 0.48 | 0.48 |

TABLE 10

| Glass sample | No. 25 | No. 25 | No. 25 | No. 26 | No. 26 | No. 26 | No. 27 | No. 27 | No. 27 |
|---|---|---|---|---|---|---|---|---|---|
| Etching time [min] | 10 | 20 | 30 | 10 | 20 | 30 | 10 | 20 | 30 |
| Through or non-through | Non- | Non- | Non- | Non- | Non- | Through | Non- | Non- | Non- |
| | through | through | through | through | through | | through | through | through |
| Thickness tB before etching [μm] | 515 | 515 | 515 | 490 | 490 | 490 | 515 | 515 | 515 |
| Thickness tA after etching [μm] | 500 | 486 | 471 | 471 | 458 | 442 | 501 | 490 | 476 |
| Thickness reduction amount Δt [μm] | 15 | 29 | 44 | 19 | 32 | 48 | 14 | 25 | 39 |
| Opening diameter Φ1 [μm] | 15 | 29 | 40 | 15 | 28 | 40 | 12 | 23 | 34 |
| Opening diameter Φ2 [μm] | 14 | 28 | 39 | 14 | 26 | 38 | 11 | 22 | 33 |
| Inner diameter Φ3 [μm] | — | — | — | — | — | 1 | — | — | — |
| Hole depth t1 [μm] | 123 | 187 | 232 | 121 | 191 | 225 | 118 | 180 | 23 |
| Hole depth t2 [μm] | 107 | 166 | 210 | 106 | 167 | 217 | 101 | 159 | 203 |
| Taper angle θ1 [°] | 3.4 | 4.4 | 4.9 | 3.5 | 4.2 | 5.0 | 2.9 | 3.6 | 4.1 |
| Taper angle θ2 [°] | 3.8 | 4.7 | 5.3 | 3.7 | 4.4 | 4.9 | 3.2 | 4.0 | 4.6 |
| Average taper angle θ [°] | 3.6 | 4.6 | 5.1 | 3.6 | 4.3 | 4.9 | 3.1 | 3.8 | 4.3 |
| ((θ1 + θ2)/2) | | | | | | | | | |
| HF etching rate [μm/min] | 0.54 | 0.54 | 0.54 | 0.51 | 0.51 | 0.51 | 0.42 | 0.42 | 0.42 |

| Glass sample | No. 28 | No. 28 | No. 28 | No. 29 | No. 29 | No. 30 | No. 30 | No. 31 | No. 31 | No. 31 |
|---|---|---|---|---|---|---|---|---|---|---|
| Etching time [min] | 10 | 20 | 30 | 20 | 30 | 20 | 30 | 10 | 20 | 30 |
| Through or non-through | Non- | Non- | Through | Non- | Non- | Non- | Non- | Non- | Non- | Non- |
| | through | through | | through | through | through | through | through | through | through |
| Thickness tB before etching [μm] | 480 | 480 | 480 | 515 | 515 | 515 | 515 | 505 | 505 | 505 |
| Thickness tA after etching [μm] | 464 | 449 | 433 | 481 | 462 | 485 | 474 | 491 | 477 | 462 |
| Thickness reduction amount Δt [μm] | 16 | 31 | 47 | 34 | 53 | 30 | 41 | 14 | 28 | 43 |
| Opening diameter Φ1 [μm] | 14 | 28 | 41 | 30 | 44 | 25 | 36 | 13 | 25 | 39 |
| Opening diameter Φ2 [μm] | 13 | 27 | 39 | 30 | 44 | 24 | 36 | 14 | 27 | 40 |
| Inner diameter Φ3 [μm] | — | — | 1 | — | — | — | — | — | — | — |
| Hole depth t1 [μm] | 103 | 169 | 223 | 183 | 228 | 171 | 219 | 119 | 175 | 227 |
| Hole depth t2 [μm] | 93 | 146 | 210 | 127 | 193 | 155 | 181 | 90 | 169 | 230 |
| Taper angle θ1 [°] | 3.9 | 4.7 | 5.1 | 4.7 | 5.5 | 4.1 | 4.7 | 3.2 | 4.1 | 5.0 |
| Taper angle θ2 [°] | 4.1 | 5.3 | 5.2 | 6.8 | 6.6 | 4.5 | 5.7 | 4.6 | 4.5 | 5.0 |
| Average taper angle θ [°] ((θ1 + θ2)/2) | 4.0 | 5.0 | 5.1 | 5.8 | 6.0 | 4.3 | 5.2 | 3.9 | 4.3 | 5.0 |
| HF etching rate [μm/min] | 0.50 | 0.50 | 0.50 | 0.58 | 0.58 | 0.47 | 0.47 | 0.54 | 0.54 | 0.54 |

TABLE 11

| Glass sample | No. 32 | No. 32 | No. 32 | No. 33 | No. 33 | No. 33 | No. 34 | No. 34 |
|---|---|---|---|---|---|---|---|---|
| Etching time [min] | 10 | 20 | 30 | 10 | 20 | 30 | 20 | 30 |
| Through or non-through | Non- | Non- | Non- | Non- | Non- | Non- | Non- | Through |
| | through | through | through | through | through | through | through | |
| Thickness tB before etching [μm] | 510 | 510 | 510 | 505 | 505 | 505 | 510 | 510 |
| Thickness tA after etching [μm] | 493 | 475 | 460 | 490 | 475 | 463 | 482 | 466 |
| Thickness reduction amount Δt [μm] | 17 | 35 | 50 | 15 | 30 | 42 | 28 | 44 |
| Opening diameter Φ1 [μm] | 16 | 32 | 46 | 14 | 26 | 37 | 26 | 39 |
| Opening diameter Φ2 [μm] | 17 | 33 | 46 | 14 | 26 | 37 | 27 | 40 |
| Inner diameter Φ3 [μm] | — | — | — | — | — | — | — | 1 |
| Hole depth t1 [μm] | 112 | 180 | 221 | 110 | 171 | 214 | 187 | 220 |
| Hole depth t2 [μm] | 118 | 160 | 209 | 63 | 164 | 222 | 167 | 239 |
| Taper angle θ1 [°] | 4.2 | 5.0 | 5.9 | 3.5 | 4.3 | 5.0 | 4.0 | 5.0 |
| Taper angle θ2 [°] | 4.2 | 5.9 | 6.2 | 6.2 | 4.6 | 4.8 | 4.6 | 4.7 |
| Average taper angle θ [°] ((θ1 + θ2)/2) | 4.2 | 5.5 | 6.1 | 4.9 | 4.4 | 4.9 | 4.3 | 4.9 |
| HF etching rate [μm/min] | 0.66 | 0.66 | 0.66 | 0.50 | 0.50 | 0.50 | 0.47 | 0.47 |

| Glass sample | No. 36 | No. 36 | No. 37 | No. 37 | No. 38 | No. 38 | No. 39 | No. 40 | No. 40 |
|---|---|---|---|---|---|---|---|---|---|
| Etching time [min] | 20 | 30 | 20 | 30 | 20 | 30 | 20 | 20 | 30 |
| Through or non-through | Non- | Non- | Non- | Non- | Non- | Non- | Non- | Non- | Non- |
| | through | through | through | through | through | through | through | through | through |
| Thickness tB before etching [μm] | 505 | 505 | 500 | 500 | 515 | 515 | 500 | 505 | 505 |
| Thickness tA after etching [μm] | 474 | 456 | 466 | 449 | 473 | 457 | 457 | 471 | 456 |
| Thickness reduction amount Δt [μm] | 31 | 49 | 34 | 51 | 42 | 58 | 43 | 34 | 49 |
| Opening diameter Φ1 [μm] | 32 | 47 | 31 | 47 | 34 | 50 | 41 | 28 | 43 |
| Opening diameter Φ2 [μm] | 32 | 48 | 31 | 45 | 35 | 49 | 42 | 29 | 42 |
| Inner diameter Φ3 [μm] | — | — | — | — | — | — | — | — | — |
| Hole depth t1 [μm] | 171 | 220 | 167 | 234 | 175 | 221 | 173 | 184 | 229 |
| Hole depth t2 [μm] | 135 | 194 | 182 | 175 | 147 | 205 | 144 | 145 | 208 |
| Taper angle θ1 [°] | 5.3 | 6.1 | 5.3 | 5.8 | 5.6 | 6.4 | 6.7 | 4.4 | 5.4 |
| Taper angle θ2 [°] | 6.7 | 7.0 | 4.9 | 7.4 | 6.8 | 6.9 | 8.2 | 5.7 | 5.8 |
| Average taper angle θ [°] ((θ1 + θ2)/2) | 6.0 | 6.6 | 5.1 | 6.6 | 6.2 | 6.6 | 7.5 | 5.1 | 5.6 |
| HF etching rate [μm/min] | 0.63 | 0.63 | 0.62 | 0.62 | 0.71 | 0.71 | 0.83 | 0.55 | 0.55 |

TABLE 12

| Glass sample | No. 41 | No. 41 | No. 42 | No. 42 | No. 43 | No. 43 | No. 44 |
|---|---|---|---|---|---|---|---|
| Etching time [min] | 10 | 30 | 10 | 30 | 20 | 30 | 10 |
| Through or non-through | Non- | Non- | Non- | Non- | Non- | Non- | Non- |
| | through | through | through | through | through | through | through |
| Thickness tB before etching [μm] | 510 | 510 | 515 | 515 | 490 | 490 | 500 |
| Thickness tA after etching [μm] | 498 | 474 | 500 | 473 | 465 | 452 | 442 |
| Thickness reduction amount Δt [μm] | 12 | 36 | 15 | 42 | 25 | 38 | 58 |
| Opening diameter Φ1 [μm] | 14 | 37 | 13 | 35 | 25 | 38 | 44 |
| Opening diameter Φ2 [μm] | 14 | 38 | 12 | 35 | 25 | 37 | 45 |
| Inner diameter Φ3 [μm] | — | — | — | — | — | — | — |
| Hole depth t1 [μm] | 126 | 230 | 126 | 238 | 173 | 224 | 93 |
| Hole depth t2 [μm] | 56 | 187 | 40 | 176 | 158 | 212 | 88 |
| Taper angle θ1 [°] | 3.1 | 4.6 | 2.9 | 4.2 | 4.1 | 4.8 | 13.5 |
| Taper angle θ2 [°] | 7.1 | 5.9 | 8.8 | 5.7 | 4.5 | 5.0 | 14.3 |
| Average taper angle θ [°] ((θ1 + θ2)/2) | 5.1 | 5.3 | 5.9 | 5.0 | 4.3 | 4.9 | 13.9 |
| HF etching rate [μm/min] | 0.51 | 0.51 | 0.44 | 0.44 | 0.46 | 0.46 | 2.37 |

As can be seen from Tables 6 to 12, the glass substrates in samples No. 1 to 43 have a low HF etching rate, and therefore the average taper angle θ of the through hole and the non-through hole thus prepared is as small as 13.0° or less. That is, a through hole and a non-through hole having high linearity are obtained.

As described above, the glass substrates according to Inventive Examples of the present invention are excellent in productivity and optical properties, and are excellent in processability of through holes and non-through holes.

### INDUSTRIAL APPLICABILITY

The glass substrate according to the present invention can be used, for example, in electronic devices such as a substrate in a micro LED display, particularly a tiling type micro LED display, and electronic components such as an interposer. In addition, the glass substrate having non-through holes according to the present invention can be used as an alignment mark or the like by filling the inside of the non-through holes with a metal.

### REFERENCE SIGNS LIST

10, 11, 12 glass substrate with holes
100 glass substrate
20, 22 through hole
21 non-through hole
31, 32 opening
40 narrowed portion
51 first tapered portion
52 second tapered portion
53 tapered portion
101 first surface
102 second surface

1. A glass substrate comprising, as a glass composition, in mol %, from 65% to 80% of SiO₂, from 5.2% to 25% of Al₂O₃, from 0% to 15% of B₂O₃, from 0.001% to less than 0.1% of Li₂O+Na₂O+K₂O, from 0% to 15% of MgO, from 0% to 15% of CaO, from 0% to 15% of SrO, from 0% to 2.9% of BaO, from 1% to 20% of MgO+CaO+SrO+BaO, and from 0% to 1% of SnO₂.

2. The glass substrate according to claim 1, comprising, as a glass composition, in mol %, from 68.9% to 80% of SiO₂, from 5.2% to 25% of Al₂O₃, from 0% to 10% of B₂O₃, from 0.001% to less than 0.1% of Li₂O+Na₂O+K₂O, from 0% to 15% of MgO, from 0% to 7.1% of CaO, from 0% to 15% of SrO, from 0% to 1% of BaO, from 1% to 20% of MgO+CaO+SrO+BaO, from 0% to 1% of SnO₂, from 0.0005% to 0.1% of TiO₂, from 0% to less than 0.05% of As₂O₃, and from 0% to less than 0.05% of Sb₂O₃, wherein a molar ratio CaO/(MgO+CaO+SrO+BaO) is from 0 to 0.67, and a molar ratio SrO/(MgO+CaO+SrO+BaO) is from 0.14 to 1.

3. The glass substrate according to claim 2, comprising, as a glass composition, in mol %, from 0% to 0.85% of BaO.

4. The glass substrate according to claim 1, comprising, as a glass composition, in mol %, from 69.1% to 80% of SiO₂, from 5.2% to 25% of Al₂O₃, from 1.1% to 8.5% of B₂O₃, from 0.001% to less than 0.1% of Li₂O+Na₂O+K₂O, from 0.1% to 15% of MgO, from 0% to 7.1% of CaO, from 0.6% to 15% of SrO, from 0% to 1% of BaO, from 1% to 20% of MgO+CaO+SrO+BaO, from 0% to 4% of ZnO, from 0.01% to 1% of SnO₂, from 0% to 0.4% of MoO₃, from 0% to less than 0.05% of As₂O₃, and from 0% to less than 0.05% of Sb₂O₃, wherein a molar ratio MgO/(MgO+CaO+SrO+BaO) is from 0.1 to 0.86, a molar ratio CaO/(MgO+CaO+SrO+BaO) is from 0 to 0.51, a molar ratio SrO/(MgO+CaO+SrO+BaO) is from 0.14 to 0.99, and a molar ratio BaO/(MgO+CaO+SrO+BaO) is from 0 to 0.06.

5. The glass substrate according to claim 4, comprising, as a glass composition, in mol %, from 0% to 4.9% of CaO.

6. The glass substrate according to claim 1, wherein a HF etching rate is 2.00 μm/min or less.

7. The glass substrate according to claim 1, wherein the glass substrate having a thickness of 1 mm has a linear transmittance of 89.5% or more at a wavelength of 450 nm.

8. The glass substrate according to claim 1, which has a temperature of 1750° C. or lower at a viscosity in high temperature of 10^{2.5} dPa·s.

9. The glass substrate according to claim 1, which has a through hole or a non-through hole.

10. The glass substrate according to claim 9, wherein
the through hole or the non-through hole includes a tapered portion, and
the tapered portion has an average taper angle of from 0° to 13.0°.

11. The glass substrate according to claim 9, wherein the through hole or the non-through hole has an opening diameter of from 1 μm to 200 μm.

12. The glass substrate according to claim 9, wherein
the glass substrate has the through hole,
the through hole has a narrowed portion therein, and
the narrowed portion has an inner diameter of from 1 μm to 200 μm.

13. The glass substrate according to claim 1, wherein
the glass substrate has an etched surface, and
the etched surface has a surface roughness Sa of from 0.05 nm to 4 nm.
